(19) United States
(12) Patent Application Publication
(10) Pub. No.: US 2023/0033408 A1
(43) Pub. Date: Feb. 2, 2023

(54) Apparatus for Applying Contact Resistance-Reducing Media and Applying Current to Plants

(71) Applicant: crop.zone GmbH, Aachen (DE)

(72) Inventors: Marcus Lehnen, Aachen (DE); Dirk Guido Vandenhirtz, Aachen (DE)

(21) Appl. No.: 17/788,731

(22) PCT Filed: Dec. 23, 2020
(86) PCT No.: PCT/EP2020/087778

§ 371 Date: Jun. 23, 2022

(30) Foreign Application Priority Data
Dec. 23, 2019 (DE) 10 2019 135 772.1
Jun. 17, 2020 (DE) 10 2020 115 925.0

(51) Int. Cl. A01G 7/04

(52) U.S. Cl. CPC A01G 7/04; A01N 25/30

(57) ABSTRACT

The invention relates to the use of a substance mixture for enhancing the effect of electric current applied to plants, wherein the substance mixture has at least one component that reduces the electrical contact resistance in the region of the plant surface, wherein the substance mixture has at least one first component containing at least one surface-active substance selected from the group consisting of surfactants and at least one second component containing at least one viscosity-increasing substance selected from the group consisting of pure silicas, fumed silicas, mixed oxides, magnesium layer silicates, organic additives based on biogenic oils and derivatives thereof, polyamides, and modified carbohydrates. The invention also relates to a method for applying electric current to plants using the substance mixture in order to exert a herbicidal effect.

### CROSS REFERENCE TO RELATED APPLICATION

This application is a U.S. National Stage entry under 35 U.S.C. § 371 based on International Application No. PCT/EP2020/087778, filed on Dec. 23, 2020, which was published under PCT Article 21(2) and which claims priority from German Application No. 102019135772.1, filed on Dec. 23, 2019 and from German Application No. 102020115925.0, filed on Jun. 17, 2020. The disclosure of each of the foregoing documents is incorporated herein by reference.

### TECHNICAL FIELD

The present invention relates to a use of a transition resistance lowering substance mixture, a method for controlling vegetation and other effects associated with the current conduction by means of the substance mixture in combination with electrophysiological plant treatments, and a device for the targeted application of the substance mixture to plants and for applying electric current to plants.

### BACKGROUND

In agriculture, in the urban area, on traffic areas and in the garden area, large amounts of systemic and non-systemic, selective and non-selective chemical herbicides for weed control, plant management and for the desiccation of crops are conventionally used. While the number of approved herbicides generally decreases, non-selective herbicides with very wide range of use and high amounts of use, such as, for example, paraquat, glufosinate, diquat and glyphosate, are greatly restricted or completely prohibited worldwide. This calls into question the profitability of individual crops, the stability and safety of transport facilities and, in particular, to maintain soil and climate-friendly cultivation forms with low soil movement.

The herbicides that can still be used in the future must, in addition to being largely free of residues, in particular of the ingredients regulated under the Plant Protection Products Act, have the lowest possible acute and chronic toxicity, be able to be shifted to other environmental compartments as little as possible, have an ecological balance that is as environmentally friendly as possible, be compatible with regulations on organic cultivation if possible, and be able to be used efficiently in climate-friendly and soil-conserving crop production. For some areas of use, compatibility with animal feeds and silage ability is important. A number of substances or substance mixtures thereof which can be produced directly from natural products or are naturally identical show an agriculturally acceptable herbicidal activity when they are used in a sufficient amount. However, the high price of pelargonic acid, for example, or the even higher cost of essential oils make it necessary to use these wax layer-destroying substances very sparingly and, accordingly, they often have an inadequate effect or are not used at all.

The mechanism of action of these above-designated chemical substances is ultimately one of physical rather than metabolic chemistry, as these non-systemic contact herbicides primarily damage the plant surface and plant cells in such a manner that the plant excessively evaporates water and therefore dries out. Although the chemical substance can wet large parts of the plants, the roots cannot be attacked directly. Even in the case of thicker stems and leaves with very stable surface layers, the substances have insufficient effect.

All systemic chemical treatment methods have in common that they require time and sufficient growing weather until the substances are distributed in the plant and take effect, especially if the roots are also to be killed. This can take up to 3 weeks. At the same time, chemical residues that are still effective mean that waiting periods of up to approx. 2 weeks must be observed with reseeding or plant emergence in order not to damage subsequent crops. Purely physical methods are even less suitable in many cases, as they often only affect the shoot of the plant in a non-systemic way and accordingly often have to be applied repeatedly and consume a lot of energy (e.g., laser, hot air, flaming, hot water), or if they have a systemic effect into the soil they also lead to damage to the soil and climate (e.g., soil agitation by plowing, soil sterilization by heat).

However, literature and practice also show applications of herbicides when, as in the case of desiccation, it is only intended to lead to faster drying of individual plant parts (e.g., potato weed, grass leafs) without killing the entire plant. In addition, applications are also possible when the plants or associated other organisms are otherwise influenced by electric current (growth acceleration, insect deterrence, etc.).

It is also known from technical literature (LANDTECHNIK 72(4), 2017, 202-213, http://DOI:10.15150/lt.2017.3165) that plants can be massively damaged by the use of hot oil (up to 250° C.) sprayed directly onto the leaves with nozzles, since the heat transfer into the leaves takes place much better here than with water application (max. 100° C. and strong evaporative cooling). These act over a larger area at close range than would be possible with hot water droplets. However, even with this non-systemic application, all plant parts to be damaged must come into direct contact with the hot oil drops. Again, this is clearly a non-systemic contact herbicide that reaches its physical limits, especially with thicker stems and high dense plant cover. The roots are not damaged. The plants die only when a very large part of the shoots are damaged and they can not regenerate from roots.

Furthermore, it has been known for a long time that plants through which high voltage electrical current flows can be systemically damaged in their water supply system down to the roots. In many cases, seed plants can die completely and root weeds can be damaged at least enough to starve them out in the medium term. Since the use of this method, ways have been sought to keep the applied voltages or the energy input as low as possible. However, hardly any systematic studies have been carried out on this—as is usual for chemical crop protection products—especially not with specific effect-enhancing formulations. Electrophysical methods have not yet been able to establish themselves as a standard method of plant control because, on the one hand, total chemical herbicides had become too cheap and, on the other hand, the social and global climatic pressure for environmentally and climate-friendly plant production within the framework of overall soil conservation management was still too low. Moreover, on the technical side, high voltages and relatively high energy consumption in the field have prevented the production of robustly working equipment with high impact power (working width×travel speed) and sufficient safety.

Traditionally, metallic applicators are used when applying current, at least to keep the electrical resistance at this point as low as possible. Furthermore, in some cases the circuit is closed not by a second contacting of plants with the opposite pole, but by electrodes cutting into the soil to reduce the total resistance. However, this halves the flow through plants (single instead of double) and thus significantly reduces efficiency.

The use of high voltages also requires wide clearances and barriers for work safety reasons (especially when metallic conductors may be present in the work area, such as in a vineyard or urban applications). The devices are correspondingly expensive due to elaborate insulation and disadvantageously large due to increased clearance requirements for creepage distances. The technical and economic applicability of corresponding devices is therefore low.

Conventional application of electricity to plants has been known to produce sparks between the applicator and plant parts, as well as deposits of an amorphous, poorly water-soluble and dark material on the applicators. It is assumed that plant hairs, unevenness and wax layers on the leaves lead to high contact resistance. The sparks generated at large potential differences between the applicators and plant parts vaporize parts of the wax layers, which are deposited on the applicators, causing additional resistance, thus requiring higher voltages and correspondingly costing more energy. No deposits occur with wet plants, since here apparently the lowered contact resistance prevents sparking, but also seems to greatly reduce the effect in general.

It is known from many years of development of plant protection products that the leaves with their hydrophobic surface structures can only be wetted sufficiently and application-specific (plant type, plant size) with the help of complexly composed formulations. Especially for grasses, with their often hyperhydrophobic, highly waxy surfaces, the electrophysical method has so far had particular problems. These are further enhanced by very closely spaced culms mixed with dead culms (especially cordgrasses, rushes).

### SUMMARY

The object is to increase the effectiveness of the application of electricity to plants. This object is solved by a novel use, by a novel method, and by a novel device. The embodiments of the invention can be combined in an advantageous manner. A first aspect of the invention relates to a use of a substance mixture for increasing the effectiveness of electric current applied to plants, which mixture comprises at least one component lowering the electrical contact resistance in the area of the plant surface, wherein the substance mixture comprises at least one first component containing at least one surface-active substance selected from the group consisting of surfactants and at least one second component comprising at least one viscosity-increasing substance selected from the group consisting of pure silicas, pyrogenic silicas, mixed oxides, magnesium layer silicates, organic additives based on biogenic oils and derivatives thereof, polyamides and modified carbohydrates.

The use of the transition resistance lowering substance mixture according to the invention advantageously allows the use of substances that do not act metabolically but physically-chemically on the leaves in combination with electrophysical treatment, e.g., to kill weeds or intercrops in one operation during a field crossing and to reseed immediately or at very short notice. Costs and growth days, which are scarce in many regions of the world, are saved. Further, the effectiveness of weed control increases significantly because the fast-germinating crops have a much greater opportunity to win light competition with weeds through early emergence. This is particularly advantageous over soil-moving weed control methods because no seeds are newly stimulated to germinate by light, etc., in the combination method described here.

The use of the substance mixture according to the invention advantageously enables hydrophobic plant surface structures and insulating air gaps to be overcome, thereby increasing the electrical conductivity between an electrical applicator and a plant and thereby enabling electrical current to be applied more effectively to the plant. Compared to conventional methods of plant destruction with herbicides or electricity, the use of the substance mixture enables an inexpensive and effective method of selectively eliminating unwanted plants.

The use of the substance mixture according to the invention makes it possible, due to the properties of the substance mixture, to transmit electric current to a plant with significantly reduced resistance compared to the application of electric current to plants only by means of solid, usually metallic applicators. The use of the substance mixture enables both a resistance-reduced overcoming of structures of the applicators interfering with the current flow (bumps, adhesions) and of the plant, such as air layers (reinforced by hairs, leaf bumps, spines), and also a more effective conduction of current in the materials and layers passed through, in such a manner that a systemic, plant-damaging effect occurs partially or up to the roots with a low energy input. The use of the substance mixture according to the invention thus increases the efficiency of a current-applying process.

The substance mixture is also referred to as a transition resistance lowering substance mixture or also as a transition resistance lowering medium. The transition resistance lowering substance mixture or medium is, for example, an aqueous liquid, a viscous liquid, a highly viscous liquid, an oil, a highly concentrated solution, a thixotropic liquid, a suspension, an emulsion, a solid, or a foam, without being limited to this enumeration.

The first component is also referred to as component A. The surface-active substance from the group of surfactants advantageously comprises nonionic surfactants and ionic surfactants with high biodegradability. The surface-active substances act beneficially when wetting a plant surface. While almost all surface-active substances can be used, classes of substances and products with high biodegradability and ecological agricultural compatibility are preferred: Nature-identical or nature-similar biosurfactants, preferably industrially available non-ionic sugar surfactants such as alkylpolyglucosides (APGs), sucrose esters, other sugar esters, methyl glycoside esters, ethyl glycoside esters, N-methylglucamides or sorbitan esters (e.g., from Solverde), amphoteric surfactants such as cocoamidopropyl betaine (CAPB) or anionic surfactants (e.g., sodium lauryl sulfate from Solverde).

Further exemplary compounds of component A are given below. In this context, enumerations, including those of the other components, are not exhaustive, but are also representative of compounds with an analogous effect in the sense of the invention, in this case the surface-active effect:
Non-ionic sugar surfactants:
Alkyl polyglucosides (APGs): The alkyl radicals have 4 to 40 carbon atoms of all possible isomers, preferably consisting of linear chains with major proportions of 8 to 14 carbon atoms as found, for example, in fatty acid alcohols produced from palm oil. The glucosides are isomers and anomers with 1-15 sugar units, preferably glucose with a degree of polymerization between 1 and 5 units or other sugar esters such as sucrose (sucrose esters), sorbitans (sorbitan esters).
Glycosidester: Esters with alcohols C1-C14 all isomers, also unsaturated and additionally functionalized with carboxylic acid, aldehyde groups and alcohol groups, preferably methyl and ethyl glycoside esters.
N-methylglucamides with carbon chains C1-C30 all isomers, also unsaturated and additionally functionalized with carboxylic acid, aldehyde groups and alcohol groups, preferably linear alkyl chains C2-C15.
Amphoteric surfactants:
Cocoamidopropyl betaine (CAPB) with carbon chains C1-C30 all isomers, also unsaturated and additionally functionalized with carboxylic acid, aldehyde groups and alcohol groups, preferably linear alkyl chains C2-C15.
Anionic surfactants:

Sodium lauryl sulfate is used as an example of an anionic surfactant. However, mixtures with various alkyl radicals (C4-C20) of LAS (linear alkylbenzene sulfonates) but also of SAS (secondary alkane sulfonates), FAS (fatty alcohol sulfates) and soaps can be used.

The second component is also referred to as component B. The viscosity-increasing substance is preferably a thixotropic substance or a substance mixture of the organic or inorganic rheological additives. The substances of component B advantageously exhibit high biocompatibility or degradability, in such a manner that they are compatible with organic farming. The substances or compounds mentioned under the substance mixtures are exemplary: pure or fumed silicas, e.g., Sipernat or Aerosil from Evonik; mixed oxides, e.g., magnesium aluminum silicates such as Attapulgit (®Attagel from BASF Formulation Additives); magnesium layered silicates, e.g., Bentonite or Hectorite (e.g., Optigel or Garamite from BYK); organic additives based on biogenic oils such as e.g., castor oil or soybean oil: e.g., Polythix from FINMA, e.g., castor oil or soybean oil: e.g., Polythix from FINMA; from the synthetic sector polyamides, e.g., polyacrylamides, e.g., Disparlon from King Industries; starch; modified celluloses, e.g., methyl cellulose, gum arabic, carmellose sodium, caragen, carbomer, hydroxy(m)ethyl cellulose, polyanionic cellulose, saccharides, tragacanth, pregelatinized starch or xanthan gum.

The biogenic oil is preferably selected from the group consisting of canola oil, sunflower oil, coconut oil, castor oil and soybean oil.

The derivatives of the oils can be, for example, their salts or esters.

The viscosity-increasing substance is preferably also the component lowering the electrical contact resistance in the area of the plant surface.

Preferably, the substance mixture has at least one further component comprising at least one conductivity-increasing substance selected from the group consisting of inorganic salts, carbon, humic substances, chelated iron, other chelated metal ions and further metal ions with complexing agents. This component is also referred to as component C. The said substances and/or substance mixtures of component C are exemplary: inorganic salts: Magnesium sulfate, Na/K2SO4; Carbon: amorphous or graphitic modifications such as graphite suspensions from CP graphite products, graphene or tubular carbon modifications, preferably also ground biochar such as plant charcoa1500+ from Egos; Counterions to the salts used in the components of the substance mixture: e.g., Na+, K+, Mg2+, Ca2+; humic substances: e.g., Liqhumus from Humintech; chelated iron: e.g., Humiron from Humintech; metal ions chelated with GLDA (tetrasodium-N,N-bis(carboxylatomethyl)-L-glutamate, e.g., from Solverde) or other biodegradable compounds, preferably iron. The metal ions can also be complexed by other complexing agents from the group of polydentate complexing agents. Instead of iron, other bivalent or trivalent metal ions can be used.

With regard to the question of conductivity-increasing substances, it should be noted that only inorganic salts and inorganic counterions of organic substances are involved in the classical increase of the conductivity of a solution. Particularly in the case of the carbon derivatives and also the higher molecular weight humic substances, the conductivity of the leaf surfaces is also increased in the case of solid substance mixtures, e.g., in the dried state of a transition resistance-lowering medium. Such drying processes occur very quickly when, for example, transition resistance lowering media are applied with low water dilution, especially on hot days, or when the liquid films are distributed over a larger surface of the sheet surface by the applicators. Therefore, specific conductivity increase is particularly advantageous in the sense of the invention.

Preferably, the substance mixture has at least one further component which is at least one hygroscopic or evaporation-reducing substance selected from the group consisting of oils, microgels and polyalcohols. This component is also referred to as component D. The said substances and/or substance mixtures of component D are exemplary: Oils: Canola oil, sunflower oil, olive oil (hot-pressed fractions to increase stability, if necessary), also finished canola oil products such as Micula from Evergreen Garden Care; microgels: Acrylic acid gels (superabsorbents); polyalcohols: Glycerol.

Preferably, the substance mixture has at least one further component comprising at least one wax-softening substance selected from the group consisting of oils, esters, alcohols, polypeptides and alkoxylated triglycerides. This component is also referred to as component E. The said substances and/or substance mixtures of component E are exemplary: Oil: Canola oil, sunflower oil, olive oil (hot-pressed fractions to increase stability, if necessary), also finished canola oil products such as Micula from Evergreen Garden Care; Ester: Fatty acid esters (esters with C1-C10 alcohols of all isomers, also unsaturated and additionally functionalized with carboxylic acid, aldehyde groups and alcohol groups), also finished products such as HASTEN (Vicchem company), a rapeseed oil ethyl ester; alkoxylated triglycerides: also as finished product KANTOR from Agroplanta.

Preferably, the substance mixture has at least one further component comprising at least one physical-phytotoxic substance and/or wax layer dissolving substance selected from the group consisting of carboxylic acids, terpenes, aromatic oils, alkalis, functionalized polypeptides, inorganic alkalis and organic alkalis. This component is also referred to as component F. Physical-phytotoxic substances are understood here as substances that unspecifically or specifically destroy the wax layer of a plant, as well as substances that have other phytotoxic effects. The said substances and/or substance mixtures of component F are exemplary: Carboxylic acids: Pelargonic acid (C9) (e.g., pelargonic acid in Finalsan from Neudorff) or other branched or unbranched carboxylic acids with shorter (<C9), equally long (=C9) or longer (>C9) linear or branched saturated or mono- or polyunsaturated carbon chains (e.g., caproic acid, caprylic acid and capric acid). These carbon chains can be additionally functionalized by further functional groups such as alcohols, aldehydes or carboxylic acid groups, either once or several times. Terpenes: oils containing terpenes; aromatic oils: Citronella oil (also finished products from Barrier/UK), eugenol e.g., from clove oil (also finished products such as Skythe/USA), pine oil (also finished products from Sustainableformulations), peppermint oils (e.g., Biox-M from Certis); alkalis: inorganic alkalis (e.g., NaOH, KOH) or organic alkalis (e.g., salts of fatty acids or humic acids e.g., Liqhumus from Humintech).

Component E can also be used to destroy the wax layer (i.e., as component F). To do this, component E must be sufficiently hot. Preferably, high-boiling organic substances with low water content or without water content are used. A hot oil is particularly preferred.

Preferably, the substance mixture has at least one further component for strengthening adhesion, which contains at least one adhesion-promoting substance and/or at least one adhesion-strengthening substance. The adhesion-promoting substance is selected from the group of foaming agents consisting of surfactants, proteins and their derivatives. The adhesion-enhancing substance (by further increasing viscosity) is selected from the group consisting of organic rheological additives, inorganic rheological additives (preferably with high biological compatibility), pure silicas, fumed silicas, mixed oxides, magnesium layer silicates, organic additives based on biogenic oils and their derivatives, and polyamides. This component is also referred to as component G. The component G causes a limited movement or distribution of the substance mixture on a corresponding plant or several, densely standing plants.

The surfactants can be non-ionic or anionic surfactants, e.g., foam markers from Kramp or protein foaming agents from Dr. Sthamer. Of the further adhesion-improving substances and/or substance mixtures of component G, the following are exemplary: pure or pyrogenic silicas: Sipernat or Aerosil from Evonik; mixed oxides: Magnesium aluminosilicates, e.g., attapulgite (®Attagel from BASF Formulation Additives); magnesium layered silicates; bentonites or hectorites (e.g., Optigel or Garamite from BYK); organic additives based on biogenic oils such as castor oil or soybean oil: Polythix from FINMA; polyamides: Disparlon from King Industries.

The biogenic oil is preferably selected from the group consisting of canola oil, sunflower oil, coconut oil, castor oil and soybean oil.

The derivatives of the oils can be, for example, their salts or esters.

Preferably, the substance mixture has at least one further component containing at least one ionization-promoting substance selected from the group consisting of inorganic salts, carbon, humic substances, chelated iron and other chelated metal ions. This component is also referred to as component H. Of the further substances and/or substance mixtures of component H, the following are exemplary: inorganic salts: Na/K2SO4 or other, counterions to salts of organic acids (Na+, K+) used; carbon: amorphous or graphitic modifications such as graphite suspensions of CP graphite products, graphene or tubular carbon modifications, preferably also ground biochar such as plant carbon500+ from Egos; humic substances: Liqhumus from Humintech; chelated iron: Humiron from Humintech, metal ions chelated with GLDA (tetrasodium-N, N-bis(carboxylatomethyl)-L-glutamate, e.g., from Solverde) or other biodegradable compounds, preferably iron.

Preferably, the substance mixture has at least one further component comprising at least one carrier liquid selected from the group consisting of water, organic liquids, vegetable oils, esters of vegetable oils and fatty acid esters. This component is also referred to as component I. The carrier liquids are advantageously suitable for diluting the substance mixture. Of the substances and/or substance mixtures of component I, exemplary are: Organic liquids: Vegetable oils; esters of vegetable oils (esters with C1-C10 alcohols, all isomers, also unsaturated and additionally functionalized with carboxylic acid, aldehyde groups and alcohol groups) and fatty acid esters (esters of fatty acids with C4-C30, thereby all isomers, also unsaturated fatty acids with C1-C10 alcohols, thereby all isomers, also unsaturated and additionally functionalized with carboxylic acid, aldehyde groups and alcohol groups).

Preferably, the substance mixture has at least one further component containing at least one substance stabilizing the storability or a tank mixture. This component is also referred to as component J. The substances and/or substance mixtures of component J are, for example, emulsifiers such as poloxamer (BASF), medium-chain triglycerides and/or biocides, preferably substances with high biodegradability.

As can be seen from the components described, there are some substances that perform a multiple function, i.e., can be used under different components, and are therefore preferred. Particular mention should be made here of humic substances, vegetable oils and their esters (esters with C1-C25 alcohols of all isomers, also unsaturated and additionally functionalized with carboxylic acid, aldehyde groups and alcohol groups, preferably fatty alcohols from natural sources), and conductivity-increasing components.

Advantageously, the substance mixture is composed of the preferred components as a function of the application objective (optional components are mentioned in brackets, which can be advantageously added depending on the application objective):

a) Application objective wetting: Mixtures of substance groups A+B (+C/D/H/I/J);

b) Application objective specific increase in the conductivity of the surface: Mixtures of substance groups A+B+C (+D/H/I/J);

c) Application objective softening of the wax layer: Mixtures of substance groups A B E (C/D/H/I/J);

d) Application objective destruction of the wax layer: Mixtures of substance groups A B F (C/D/H/I/J);

e) Application objective bridging of resistances: Mixtures of substance groups A B G (C/D/H/I/J);

f) Component H is only used if the electrostatic charge of plants and medium can be used;

g) Other combinations of A+B with components C/D/E/F/G/H/I/J can be used to cause combination effects to increase effectiveness.

Advantageous for the destruction of the wax layer before or during the electrophysical treatment is the destruction with heated media in general and especially with hot oil (in component E) in the areas in contact with the electrical applicators. The necessary dosed spraying of small amounts of hot oil (0.5-20 l/ha, preferably 2-10 l/ha) only on the upper leaf areas greatly reduces the application rate compared to the pure (known) killing of the plants by hot oil, because the electrophysical treatment with low resistance then acts systemically.

Preferably, the substance mixture has at least one further component in addition to the first component (component A) and the second component (component B), the further component being component C, component E and/or component F. Components C, E, and F are particularly effective, both individually and in combination, in lowering electrical contact resistance around the plant surface. The contact resistance is significantly reduced by the increase in conductivity in layers in the area of the plant surface (component C), by the softening (softening) of the layers in the area of the plant surface (component E) and/or by the dissolution (destruction) of the layers in the area of the plant surface (component F) compared to a treatment without the substance mixture.

As component C, the substance mixture preferably has humic substances and/or chelated iron, the chelated iron preferably being iron chelated by humic acids. As component F, the substance mixture preferably comprises fatty acids, mixtures of fatty acids and/or alkalized humic substances, the fatty acids preferably being present in alkalized and/or chelated form.

Particularly preferably, the substance mixture has at least one further component in addition to the first component (component A) and the second component (component B), the further component being component C and/or component E.

Preferably, the substance mixture has at least one further component in addition to the first component (component A) and the second component (component B), the further component being component C, component D and/or component E.

A second aspect of the invention relates to a method of applying electric current to plants to exert a herbicidal effect, comprising the steps of:
selective application of a substance mixture to at least one plant part, the substance mixture having at least one component which lowers the electrical contact resistance in the area of the plant surface, the substance mixture having at least one first component which contains at least one surface-active substance selected from the group consisting of surfactants and at least one second component comprising at least one viscosity-increasing substance selected from the group consisting of pure silicas, pyrogenic silicas, mixed oxides, magnesium layer silicates, organic additives based on biogenic oils and derivatives thereof, polyamides and modified carbohydrates;
Applying electric current to the plant part wetted by the substance mixture.

A third aspect of the invention relates to a device for carrying out a process according to the invention, comprising at least two modules, a first module having at least one application apparatus for applying a substance mixture to plants or plant parts, and a second module having at least one application apparatus for applying electric current to plants or plant parts, the substance mixture having at least one component which lowers the electrical contact resistance in the area of the plant surface, wherein the substance mixture comprises at least one first component containing at least one surface-active substance selected from the group consisting of surfactants, and at least one second component containing at least one viscosity-increasing substance selected from the group consisting of pure silicas, pyrogenic silicas, mixed oxides, magnesium layer silicates, organic additives based on biogenic oils and derivatives thereof, polyamides and modified carbohydrates. The two modules can be arranged spatially very close to one another, in such a manner that the application apparatus can apply the substance mixture directly in front of or directly onto the electric applicators. The medium can therefore be applied directly to the plants or indirectly via the applicators. The latter embodiment is particularly advantageous in enabling precise application of current.

The device according to the invention advantageously enables a coordinated application of the substance mixture to the plant parts to which current is to be applied by means of applicators. The device advantageously enables destruction of plants of different species and sizes. In doing so, the device enables precise application of the substance mixture to an applicator-accessible surface: Since the systemically acting current from the applicators must be fed into the conduction paths of the leaves and stems touched by the applicators, only the leaves and stems that can be reached by applicators must also be hit by the transition resistance lowering medium (i.e., the substance mixture). This means that the application of the liquid, which may be highly viscous, must be very controllable and selective—on the surface and in the same direction—with the appropriate applicator arrangement (e.g., from above or from the side).

Furthermore, by means of the device, the substance mixture can be deposited on the surface of a plant part, e.g., one or more leaves, in a conductivity-increasing manner. The active ingredient (current) mediated, for example, by transition resistance lowering media does not penetrate the sheets by diffusion, but penetrates selectively when both the air gap between the applicator and the sheet and the wax layers or other barrier layers are bridged by the transition resistance lowering medium. Accordingly, it is important for surface-altering effects to reach the leaf surface, but at the same time the bridging film thickness must be maintained by viscosity, thixotropy, or liquid cooling. Widening of the contact surface can then still be achieved by mechanical contact with the electrical applicator.

Furthermore, the device enables economical metering of the substance mixture. Furthermore, the device can be used to apply highly concentrated, highly viscous substance mixtures, thus accelerating their effect. If too much is applied (rain wetness or too large a liquid application rate), the flow will run off the outside of the plants ineffectively into the soil directly. Full or complete wetting of the plant is accordingly counterproductive.

In addition, the device, in combination with the transition resistance lowering medium adapted to the treatment circumstances, enables the process to become effective quickly. The effects necessary on the leaf surface to reduce resistance must occur quickly, since in many cases it makes sense for the time interval between application of the transition resistance lowering medium and electrical application to be only fractions of a second to seconds (7.2 km/h corresponds to 2 m per s, i.e., a distance of 6 m tractor length corresponds to an application time of 3 s if applied at the front of the tractor and electrophysically treated at the rear. At a distance of 50 cm, exposure times of 0.5 s are achieved).

Furthermore, the device advantageously allows the substance mixture, which is designed to be sufficiently temperature-stable for this purpose, to be heated before application. Processes such as diffusion and dissolution are massively accelerated by increased temperatures. Precisely because the wax layers consist of substances with a melting point in the range of 50 to 100° C. as a pure substance, heating precisely these thin layers can efficiently help to destroy them quickly and thus make the leafs more conductive. Particularly strong heating is possible if the substance mixtures contain only small amounts of water and can then be heated to 100° C. or higher during atomization or coating. The surface-active substances contained in the mixture advantageously reduce the evaporation and thus the cooling of liquids, especially of spray drops. It is also advantageous to use nozzles with a jacket flow heated, for example, by generator or tractor exhaust gases, in such a manner that the liquid droplets cool as little as possible between atomization and impact on the plant and can be guided specifically even at higher speeds. Particularly for preheating the liquids before spraying or during coating, it makes sense to use the waste cooling water heat and the waste gas heat from the tractor or power generator to save energy.

In addition to heating the application apparatus, the device advantageously also enables heating of the application apparatus. In this way, considerable temperature losses due to fine distribution of a spray medium, for example, can be reduced or avoided. At the same time, only the areas which are actually used for power transmission are heated. This saves energy and allows the use of even highly aqueous media, some of which may evaporate during electrophysical treatment. Also, media applied in a highly viscous form can then, on the one hand, fulfill their bridging function through heating, but on the other hand, they can also be distributed broadly mechanically only during electrophysical treatment by the applicators lying on top, thus achieving a maximum contact effect.

Further disclosed is a use of a substance mixture for enhancing the effect of electric current applied to plants, wherein the substance mixture comprises at least one component lowering the electrical contact resistance in the area of the plant surface, wherein the substance mixture comprises at least two components selected from the group consisting of a component C, a component E and a component F, wherein component C contains at least one conductivity-increasing substance selected from the group consisting of inorganic salts, carbon, humic substances, chelated iron, other chelated metal ions and metal ions with complexing agents, wherein component E comprises at least one wax softening substance selected from the group consisting of oils, esters, alcohols, polypeptides and alkoxylated triglycerides, and wherein component F contains at least one physical phytotoxic and/or wax layer dissolving substance selected from the group consisting of carboxylic acids, terpenes, aromatic oils, alkalis, functionalized polypeptides, inorganic alkalis and organic alkalis.

Components C, E and F of the substance mixture of the disclosed use correspond to components C, E and F of the substance mixture described above for the use according to the invention. The features and examples of components C, E and F described for the substance mixture of the use according to the invention therefore apply equally to the substance mixture of the disclosed use.

Preferably, the substance mixture of the disclosed use has either component C and component E or component C and component F.

Preferably, the substance mixture of the disclosed use has at least one further component, wherein the further component is selected from the group consisting of a component A, a component B, a component D, a component G, a component H, a component I, and a component J.

Components A, B, D, G, H, I and J of the substance mixture of the disclosed use correspond to components A, B, D, G, H, I and J of the substance mixture described above for the use according to the invention. The features and examples of components A, B, D, G, H, I and J described for the substance mixture of the use according to the invention therefore apply equally to the substance mixture of the disclosed use.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIGS. 1A, 1B and 1C show possible arrangements of a device according to the invention on a carrier vehicle.

FIGS. 2A and 2B show further possible arrangements of the device according to the invention on the carrier vehicle.

FIGS. 3A, 3B, 3C and 3D show a comparative presentation of different methods for conventional (A-C) and (D) weed control according to the invention.

FIGS. 4A and 4B show a schematic representation of a plant.

FIG. 5 is a schematic representation of a plant.

FIGS. 6A and 6B show a schematic representation of a plant with an electric applicator.

FIGS. 7A and 7B show a schematic representation of a plant with an electric applicator and a transition resistance lowering medium.

FIGS. 8A and 8B show a schematic representation of a plant with an electric applicator, a transition resistance lowering medium and wax layer softening substances.

FIGS. 9A and 9B show a schematic representation of a plant with an electric applicator, a transition resistance lowering medium and wax layer destroying substances.

FIGS. 10A and 10B a schematic representation of a plant with an electric applicator and foam.

FIGS. 11A and 11B show an experimental plan of a terrain section for treating plants by the method according to the invention.

FIG. 12 shows an experimental field section in which the method according to the invention is carried out.

FIG. 13 shows the results of the treatment of grain by means of the method according to the invention.

FIGS. 14A and 14B show the experimental arrangement for treating potatoes by means of the method according to the invention.

FIG. 15 shows the results of the treatment of potatoes by means of the method according to the invention.

FIG. 16 shows the results of the treatment of potatoes by means of the method according to the invention in combination with a chemical secondary treatment.

FIG. 17 shows the results of the treatment of potatoes by means of the method according to the invention, wherein the treatment was carried out twice.

FIG. 18 shows the results of the treatment of potatoes by means of the method according to the invention, wherein four different treatment patterns were tested.

FIG. 19 shows the experimental arrangement for the treatment of potatoes by means of the method according to the invention in combination with haulm topping.

FIG. 20 shows the results of the treatment of potatoes by means of the method according to the invention in comparison to haulm topping.

FIG. 21 shows the results of the treatment of potatoes by means of the method according to the invention in comparison with haulm topping, wherein the treatment was carried out twice by means of the method according to the invention.

FIG. 22 shows the results of the treatment of potatoes by means of the method according to the invention in combination with haulm topping.

### DETAILED DESCRIPTION

Reference will now be made in detail to some embodiments of the invention, examples of which are illustrated in the accompanying drawings.

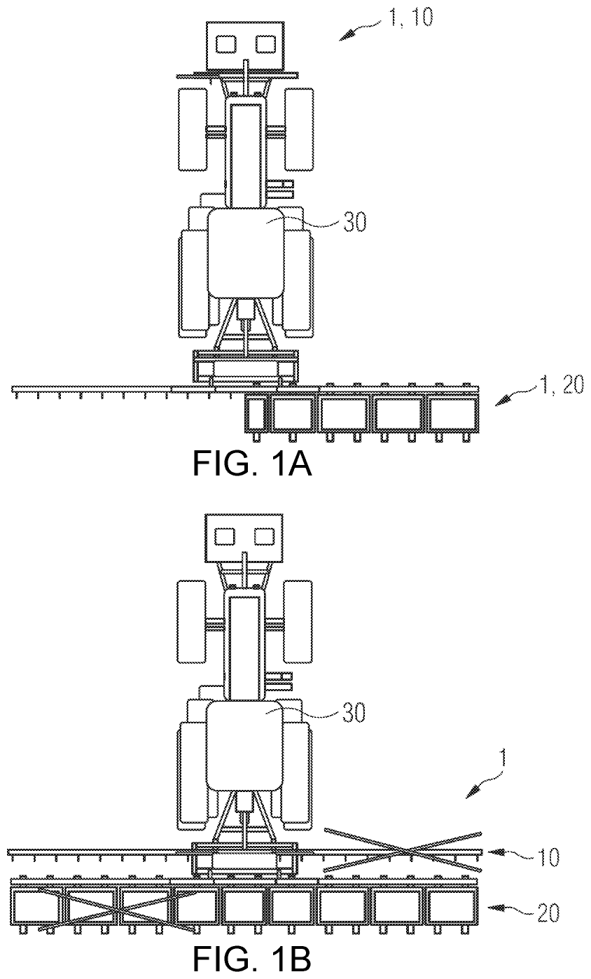

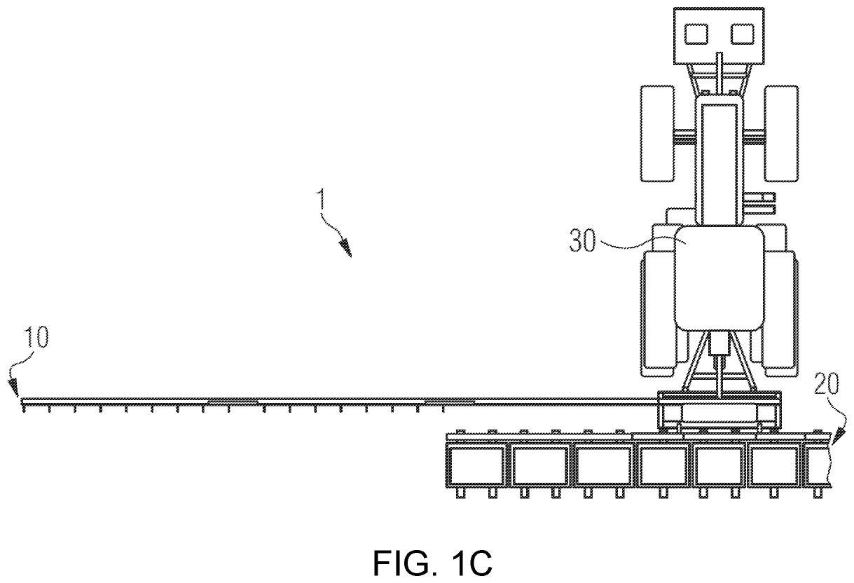

FIGS. 1A, 1B and 1C show the arrangement of the individual components of the device 1 according to the invention for applying a substance mixture to a tractor serving as a carrier vehicle 30, drive and energy supplier. The substance mixtures has a conductivity-improving effect, and can also be referred to as a transition resistance lowering medium; in the following, the term “transition resistance lowering medium” is used here. The device 1 has a first module 10 for applying the transition resistance lowering medium to plant parts and a second module 20 for applying electric current to the plant parts wetted by the transition resistance lowering medium.

The arrangement of the device 1 and the carrier vehicle 30 may vary depending on the mode of use and specific requirements of the crop in question and the time of treatment. For this purpose, FIGS. 1A, 1B and 1C show possible arrangements of the first module 10 and the second module 20. Of the total possible working width of the device 1, one half is actively used only for the distribution of the transition resistance lowering medium by means of the first module 10, while on the other half the second module 20 applies electric current on the surface already chemically treated during the previous pass. In the embodiment shown in FIG. 1A, the first module 10 and the second module 20 are each only half populated. In the embodiment shown in FIG. 1B, the first module 10 and the second module 20 are each double loaded but only half in operation and can be freely changed (FIG. 1B). In the embodiment according to FIG. 1C, the first module 10 can be moved separately or swung out twice and can therefore be used flexibly on the right, left or simultaneously. The arrangements shown in FIGS. 1A, 1B and 1C allow plants to be treated at minute intervals.

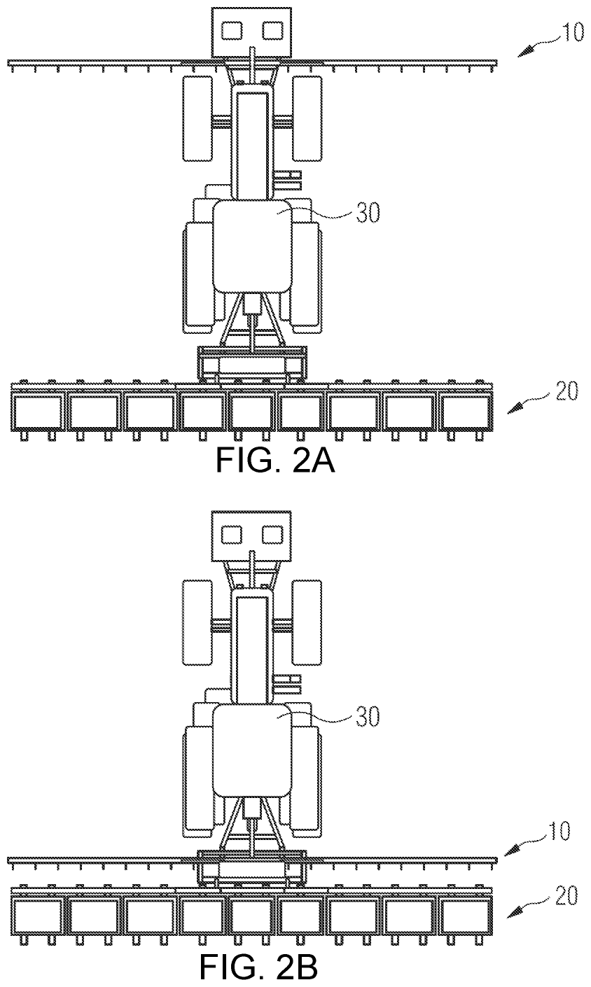

The embodiments of the device 1 according to FIGS. 2A and 2B allow treatment of plants within seconds (FIG. 2A) or fractions of seconds (FIG. 2B). In FIG. 2A, the first module 10 is located at the front of the carrier vehicle 30. In this embodiment, after the application of the transition resistance lowering medium, a few seconds pass before the second module 20 arranged at the rear of the carrier vehicle 30 reaches the plants to be treated. In FIG. 2B, the first module 10 is located on the vehicle side of the second module 20 at the rear of the carrier vehicle 30. Here, only fractions of a second pass after the application of the transition resistance lowering medium until the second module 20 reaches the plants to be treated. The latter configuration may be preferred if the acceleration of action by suitable substances, hot media or heated applicators is sufficient for resistance reduction.

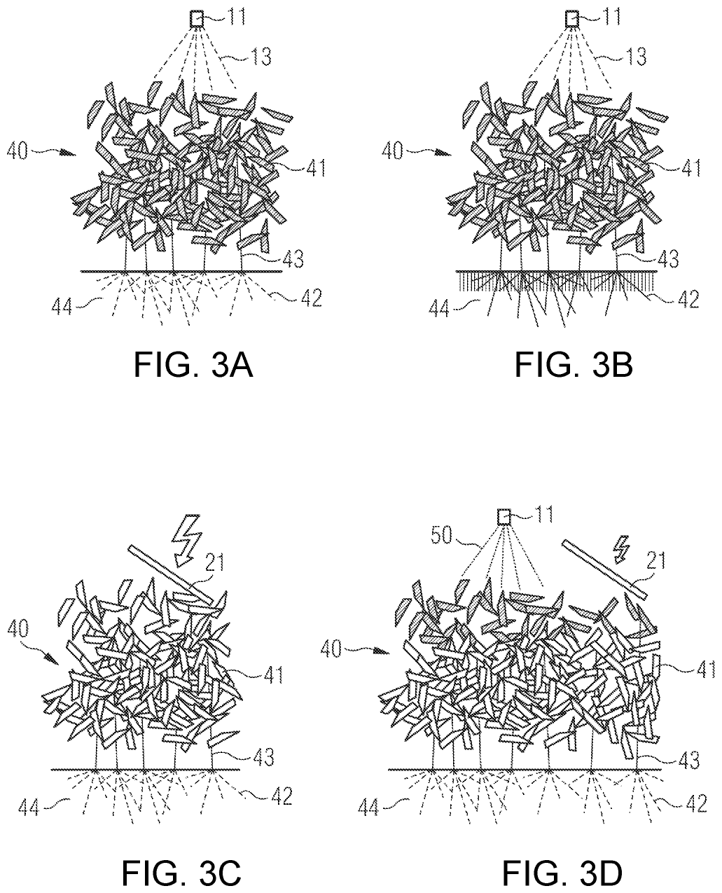

FIGS. 3A, 3B, 3C and 3D compare different herbicidal methods of plant treatments. In a conventional process as shown in FIG. 3A, systemic nonselective herbicides 13 are applied mainly by nozzles 11 from above to the plants 40 and spread by the sap flow over all leaves 41 (hatching) into the roots 42, which are then also destroyed (dashing). A large proportion of these substances are now banned or are likely to be in the future. Their main effect is the disruption or alteration of chemical metabolic pathways in the plant, which then leads to its death down to the roots.

In a conventional process shown in FIG. 3B, nonselective contact herbicides 13 are applied to the leaves 41 and stems 43 over as full a surface area as possible by spraying (hatching), which requires large amounts of active ingredient and water and also increases direct wetting of the soil 44. Nevertheless, the effect is only on the leaves 41 and stems 43 (hatching). Root weeds are poorly controlled because the roots 42 are not killed directly (solid lines, not dashed). The action of contact herbicides can almost be considered physical in some cases, when its main effect is to damage the wax layer as an evaporation barrier.

In a conventional method shown in FIG. 3C, electrophysical methods are used, wherein electric current is applied to the plants 40 from above, which can damage them down to the root 42. The main mechanism of action is the destruction of water-conducting vessels in the stems (petioles) 43 and roots 42, which then leads to desiccation into the roots 42. However, this requires a lot of energy and high voltages to overcome the resistance barrier between leaf 41 and applicator 21. The electrical applicator 21 need only touch the leaves 41 at the top of the plant 40 to pass the current through the leaf 41 and stem (petioles) 43 and into the roots 42 to kill.

In the process in accordance with the invention as shown in FIG. 3D, a synergistic effect is achieved by combining resistance lowering substances (transition resistance lowering medium 50) and electrophysical treatment. The transition resistance lowering medium 50 applied only to the uppermost leaf level reduces the resistance at the transition surface from applicator 21 to leaf 41, thereby reducing the voltage and electrical power required. The plant 40 is thus destroyed systemically to the root 42. In many cases, it is possible to completely dispense with substances that are subject to the Plant Protection Products Act or are not permitted in the organic sector.

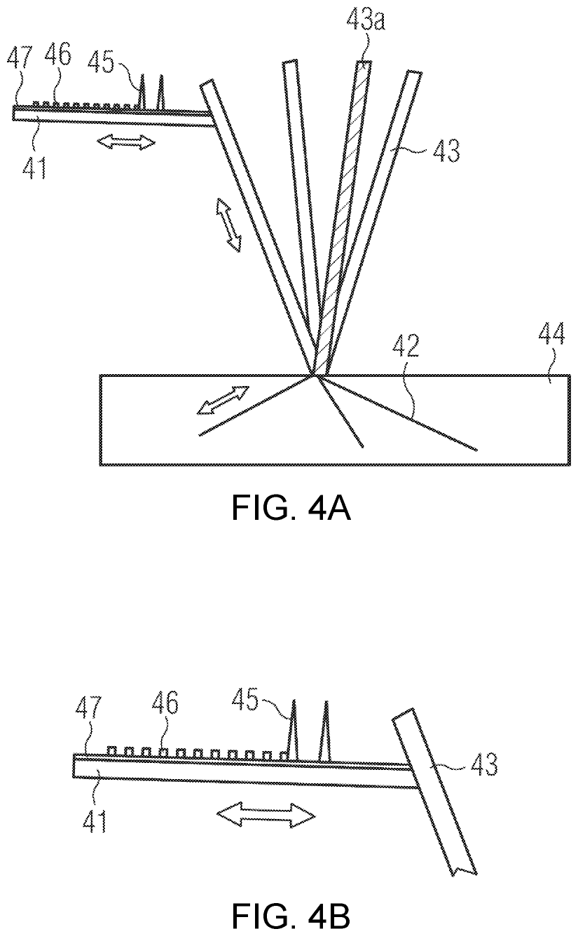

FIG. 4A shows a plant 40 abstractly. Plants are composed mainly of leaves 41, roots 42, and stems 43, with young grasses showing mainly leaves but no stems. Especially in grasses, old dead leaves or stems 43a can last a long time. Many plants 40 form spines 45 and hairs 46 of varying hardness and size on leaves 41 or on stems 43, which are often additionally reinforced with waxes. In addition, wax layers 47 protect the leaves from drying out on the one hand, but also from wetting by water and invading pathogens on the other. In plants, all organs in the conducting bundles transport both water and minerals upward and nutrients downward into the roots 42. The arrows represent the water conductivity of the plant organs. In FIG. 4B, a section of the leaf 41 of FIG. 4A is shown enlarged, wherein the spines 45, the pubescence 46 and the wax layer 47 are more clearly visible.

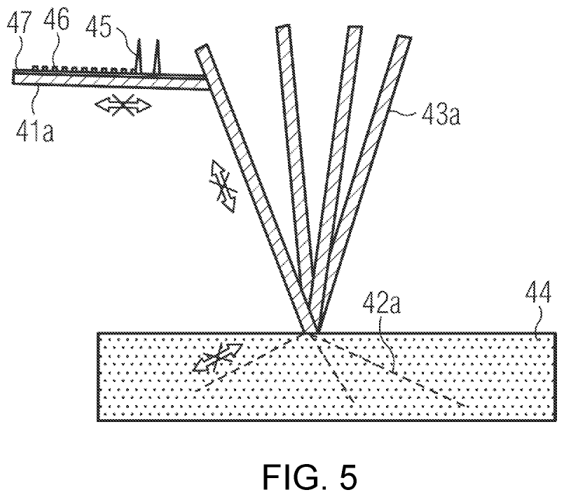

FIG. 5 illustrates the destruction of water conductivity (crossed-out arrows). To cause plants 40 to die, it is necessary to destroy or at least severely damage some or all of the plant organs (dead leaves 41a, dead roots 42a, dead stems 43a), depending on the plant species and plant size. In some cases, destruction of the above-ground organs (leaves and stems) by non-systemic herbicides, for example, is sufficient, while other plants can always regrow from the root as long as they are not consistently starved. Systemic herbicides are needed here to kill even roots without soil movement, at least to a certain depth. The destruction of water conductivity is only one of many ways to destroy the metabolism of plants.

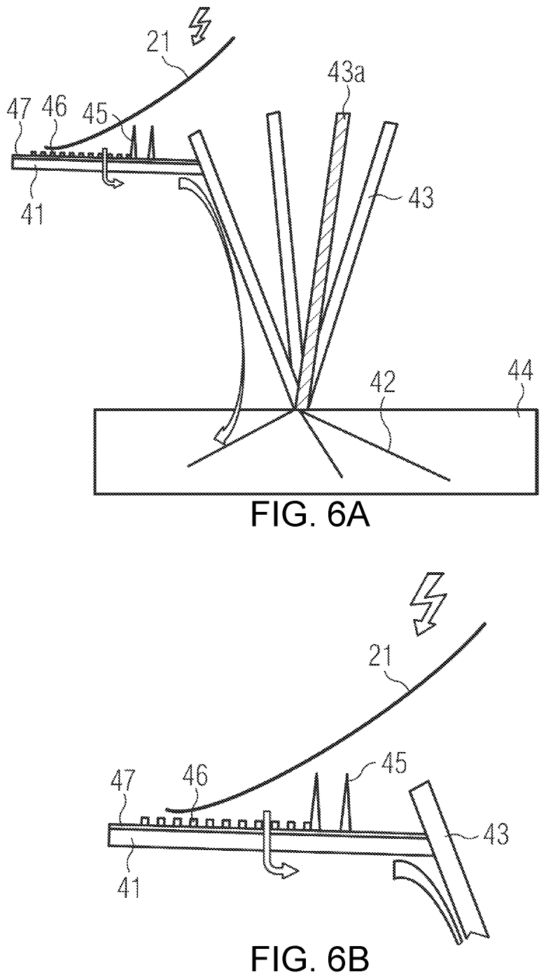

In FIG. 6A, the application of electric current to the plant 40 by an applicator 21 is shown. The arrows represent the current flow. Bumps in leaves 41, spines 45, and leaf hairs 46 keep electric applicators 21 at a distance when plants 40 are to be killed by electric current. The resulting air layer between leaf 41 and applicator 21 and the small contact area cause a high electrical resistance. This is massively increased by a wax layer 47 present on many leaves 41. High voltages are required to inject sufficient current into the plant, and much energy is dissipated unused by sparkovers. Local heating of the wax layer 47 due to resistance and plasma discharges during contact with the applicator 21 results in transfers of plant wax 47 to the applicators 21, where it forms a partially insulating layer. As a result, the electrical resistance is increased again and the current flow is reduced.

In FIG. 6B, a section of the leaf 41 of FIG. 6A is shown enlarged, wherein the spines 45, the pubescence 46 and the wax layer 47 are more clearly visible.

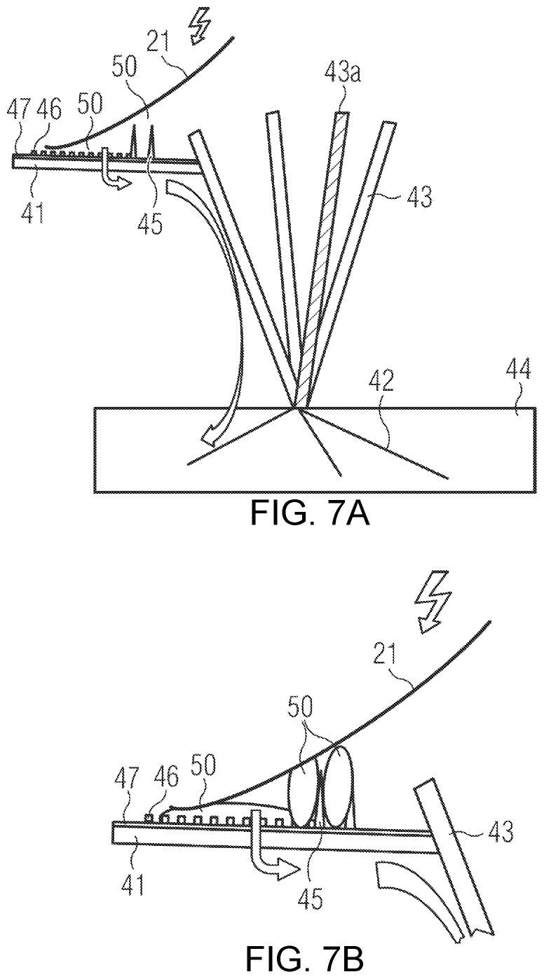

FIG. 7A illustrates the use of electrically conductive fluids (contact resistance lowering medium 50) wetting the leaves 41. The transition resistance lowering medium 50 displaces insulating air between the leaf 41 and the applicator 21 with a conductive or conductivity increasing medium. This reduces the contact resistance, increases the contact area and reduces deposits on the applicators 21, since the vegetable wax is less heated or can be better removed by moist abrasion. Therefore, for the same voltage, the current flow increases. The arrows represent the current flow. In FIG. 7B, a section of the leaf 41 of FIG. 7A is shown enlarged, wherein the spines 45, the pubescence 46 and the wax layer 47 are more clearly visible. In this case, it can be seen more clearly how the transition resistance lowering medium 50 penetrates into the spaces between the spines 45 and the plant hairs 46.

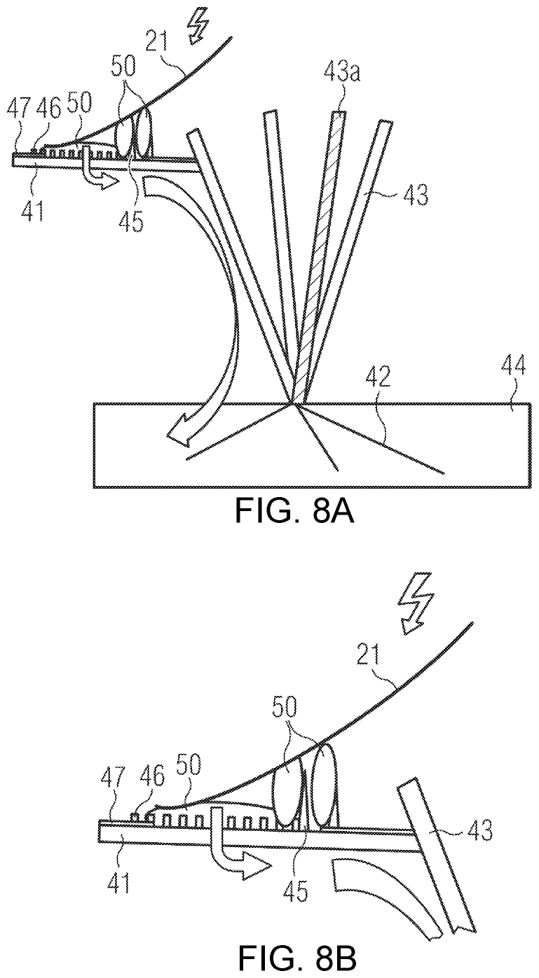

FIG. 8A illustrates the use of substances in the transition resistance lowering medium 50, which soften the wax layer 47 and thus also make it more conductive. This allows the electrical contact resistance to be lowered even further. At the same voltage, the current flow increases (represented by thicker arrows compared to FIGS. 7A and 7B) or less voltage is required to achieve a defined current flow to destroy the conductive bundles. In FIG. 8B, a section of the leaf 41 of FIG. 8A is shown enlarged, wherein the spines 45, the pubescence 46 and the wax layer 47 are more clearly visible.

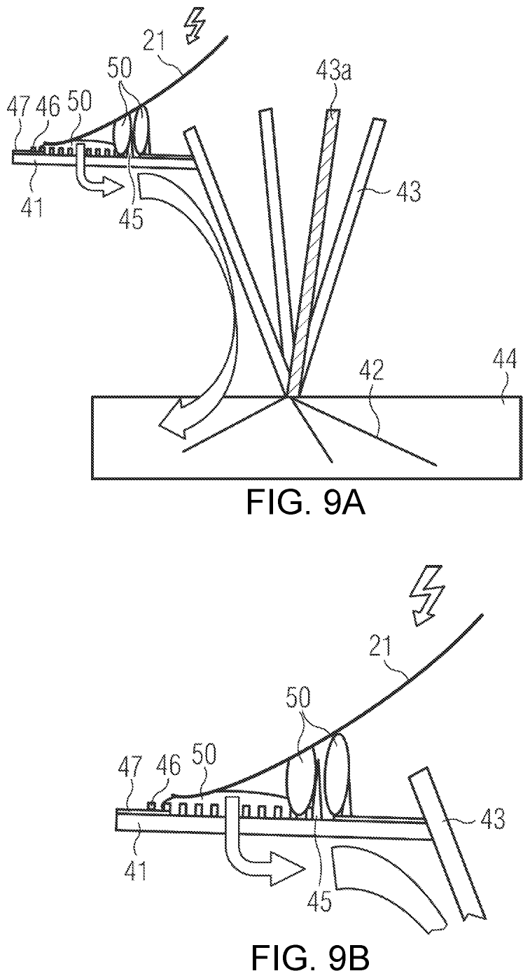

FIG. 9A illustrates the use of substances in the transition resistance lowering medium 50 that dissolve and destroy the wax layer 47, and the destruction can be further accelerated by applying heat. As a result, the volume resistance can be reduced even further. At the same voltage, the current flow increases (represented by even thicker arrows compared to FIGS. 8A and 8B). This also allows the amount of current required to destroy the plant 40 to the root 42 to be lowered even further. The high dissolving power also leads to continuous cleaning of the electrical applicators 21, in such a manner that no more insulating boundary layers are formed there. In FIG. 9B, a section of the leaf 41 of FIG. 9A is shown enlarged, wherein the spines 45, the pubescence 46 and the wax layer 47 are more clearly visible.

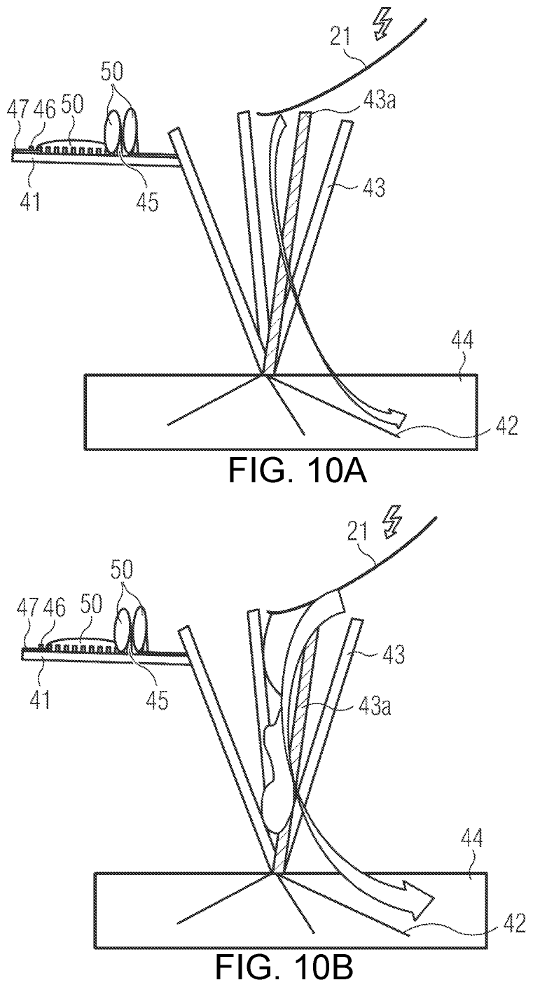

FIG. 10A illustrates the problem of dead leaves or heavily woody stems reducing the conductivity of the plants, making it difficult to access the root. By using highly viscous liquids or foams 51 (FIG. 10B) that flow down the outside of the plant shoots but do not make direct contact with the soil, the poorly conducting areas (dead stem 43a in this case) can be bypassed and current can be more effectively conducted into the roots 42.

A target-oriented use of mixtures of the transition resistance lowering medium 50 preferred for certain uses is explained below. The component name always refers to the groups of chemical compounds designated in the text. Preferred components from this group are then named in further columns. The total application volume is preferably 10-200 l/ha (water-based) or 30-200 l/ha (water-based) or 5-30 l/ha (oil-based), depending on the crop height, with the aim of reaching only the uppermost leaf level that can be reached by applicators. The application rate refers to full-surface treatment when spraying on closed plant covers. If more than one component is specified for a target, these components may be used alone or as a mixture until the total application rate is reached. If alternative ranges are necessary for the quantity specifications, they are described separately. The media carrier water or vegetable oil-based components are not listed in the table, as they are always used to supplement the application volume.

All substances from each of the specially adjusted substance classes are tested individually and at least in 1:1 mixtures.

The substances that are particularly effective for lowering the contact resistance are in component classes C, E and F, i.e., conductivity increase, wax layer softening and wax layer destruction, and here in particular the use of humic substances, chelated iron (possibly chelated by humic substances) and fatty acid mixtures preferably in alkalized and where necessary chelated form.

Table 1 summarizes water-based transition resistance lowering media 50. These are especially intended for use on dicotyledonous plants.

TABLE 1

| | | Application rate to | Application rate | Application rate |
|---|---|---|---|---|
| | | be set generally kg/ha | to be set | to be set |
| | | Substance class | preferred kg/ha | Especially kg/ha |
| Component | | according to list | preferred substance | preferred |
| name | Function | component name | classes | substance class |
| A | Surfactant | 0-4 | 0-2 APGs, sugar | 0.2-0.5 sugar |
| | | | esters, CAPB | ester, cAPB |
| B | Thickener | 0-5 | 0-3 silicas mixed oxide | 0-2 silicas |
| | | | silicates | mixed oxide |
| | | | phyllosilicates, mod. | silicates |
| | | | celluloses | phyllosilicates |
| C | Conductivity | 1-10 | 1-10 sulphates, humic | 1-10 humic |
| | Increaser | | substances, chelated | substances, |
| | | | iron (GLDA) | chelated iron, |
| | | | | chelated with |
| | | | | humic acids, |
| | | | | alkalized |
| D | Evaporation- | 0.1-10 | 0.1-5 Vegetable | 0.1-2 |
| | reducing | | oils/vegetable oil ester | Vegetable oils |
| E | Wax layer- | 0.1-40 | 0.2-20, oils, | 0.5-10 oils, fatty |
| | softening | | polypeptides, fatty | acid esters, |
| | | | acid esters, carboxylic | carboxylic acids |
| | | | acid | |
| F | Wax layer | 0-40 | 0-20 fatty acids, | 0-10, non-toxic |
| | destroyer | | (pelargonic acid only | carboxylic acids, |
| | | | in dosages of 0-50% | Iron-containing |
| | | | of the amounts | metal soaps, |
| | | | permitted in PSM for | alkalized humic |
| | | | the respective culture) | materials |
| | | | Terpene oils, alkalized | |
| | | | humic substances, | |
| | | | iron-containing metal | |
| | | | soaps | |

Table 2 summarizes oil-based transition resistance-reducing media 50. These are primarily provided for use on dicotyledonous plants.

TABLE 2

| | | Application rate to | Application rate | Application rate |
|---|---|---|---|---|
| | | be set generally kg/ha | to be set | to be set |
| | | Material class | preferred kg/ha | Especially kg/ha |
| Component | | after list of | preferred substance | preferred substance |
| name | Function | components name | classes | class |
| A | Surfactant | 0-2 | 0-1 APGs, sugar | 0-0.2 sugar ester, |
| | | | esters, CAPB | cAPB |
| B | Thickener | 0-2 | 0-2 silicas mixed | 0-1 silicas mixed |
| | | | oxide silicates | oxide silicates |
| | | | phyllosilicates, mod. | phyllosilicates, mod |
| | | | celluloses | celluloses |
| C | Conductivity | 1-10 | 1-10 sulphates, | 1-10 humic |
| | Increaser | | humic substances, | substances, |
| | | | chelated iron | chelated iron, |
| | | | (GLDA) | chelated with humic |
| | | | | acids, alkalized |
| D | Hygroscopic | 0.1-10 | 0.1-5 Glycerol, | 0.1-2 |
| | substances | | microgels | Glycerol |
| E | Wax layer | 0.1-40 | 0.2-20, oils, | 0.5-10 oils, fatty |
| | softener | | polypeptides, fatty | acid esters, |
| | | | acid esters, | carboxylic acids |
| | | | carboxylic acid | |
| F | Wax layer | 0-40 | 0-20 fatty acids, | 0-10, non-toxic |
| | destroyer | | (pelargonic acid only | carboxylic acids, |
| | | | in dosages of 0-50% | Iron-containing |
| | | | of the amounts | metal soaps, |
| | | | permitted in PSM for | alkalized humic |
| | | | the respective | materials |
| | | | culture) | |
| | | | Terpene oils, | |
| | | | alkalized humic | |
| | | | substances, iron- | |
| | | | containing metal | |
| | | | soaps | |

Table 3 summarizes transition resistance reducing media 50 for droplet applications. These are provided primarily for use on grasses.

TABLE 3

| | | Amount of effort | | |
|---|---|---|---|---|
| | | to be included | Application rate | Application rate |
| | | generally kg/ha | to be set | to be set |
| | | Substance class | preferred kg/ha | Especially kg/ha |
| Component | | according to list | preferred | preferred |
| name | Function | Component name | substance classes | substance class |
| A | Surfactant | 0-3 | 0-2 APGs, sugar | 0.2-0.5 sugar ester, |
| | | | esters, CAPB | cAPB |
| B | Thickener | 0-10 | 0-5 silicas mixed | 1-5 silicas mixed |
| | | | oxide silicates | oxide silicates |
| | | | phyllosilicates, | phyllosilicates, |
| | | | mod. celluloses | mod. celluloses |
| C | Conductivity | 1-10 | 1-10 sulphates, | 1-10 humic |
| | increaser | | humic substances, | substances, |
| | | | chelated iron | chelated iron, |
| | | | (GLDA) | chelated with |
| | | | | humic acids, |
| | | | | alkalized |
| D | Evaporation- | 0.1-10 | 0.1-5 Vegetable | 0.1-2 |
| | reducing | | oils/vegetable oil | Vegetable oils |
| | substances | | ester | |
| E | Wax layer | 0.1-40 | 0.2-20, oils, | 0.5-10 oils, fatty |
| | softener | | polypeptides, fatty | acid esters, |
| | | | acid esters, | carboxylic acids |
| | | | carboxylic acid | |
| F | Wax layer | 0-40 | 0-20 fatty acids, | 0-10, non-toxic |
| | destroyer | | (pelargonic acid | carboxylic acids, |
| | | | only in dosages of | Iron-containing |
| | | | 0-50% of the | metal soaps, |
| | | | amounts permitted | alkalized humic |
| | | | in PSM for the | materials |
| | | | respective culture) | |
| | | | Terpene oils, | |
| | | | alkalized humic | |
| | | | substances, iron- | |
| | | | containing metal | |
| | | | soaps | |

Table 4 summarizes transition resistance lowering media 50 for foam-based applications. These are provided primarily for use on grasses.

TABLE 4

| | | Amount of effort | | |
|---|---|---|---|---|
| | | to be included | Application | Application |
| | | generally kg/ha | rate to be set | rate to be set |
| | | Substance class | preferred kg/ha | Especially kg/ha |
| Component | | according to list | preferred substance | preferred |
| name | Function | Component name | classes | substance class |
| A | Surfactant | 0-4 | 0-2 APGs, sugar | 0.2-0.5 sugar |
| | | | esters, CAPB | ester, cAPB |
| B | Thickener | 0-2 | 0-2 silicas mixed | 0-2 silicas mixed |
| | | | oxide silicates | oxide silicates |
| | | | phyllosilicates, | phyllosilicates |
| | | | mod. celluloses | |
| C | Conductivity | 1-10 | 1-10 sulphates, | 1-10 humic |
| | increaser | | humic substances, | substances, |
| | | | chelated iron | chelated iron, |
| | | | (GLDA) | chelated with |
| | | | | humic acids, |
| | | | | alkalized |
| D | Evaporation- | 0.1-10 | 0.1-5 Vegetable | 0.1-2 |
| | reducing | | oils/vegetable oil | Vegetable oils |
| | | | ester | Glycerol |
| | | | Glycerol, microgels | |
| E | Wax layer | 0.1-40 | 0.2-20, oils, | 0.5-10 oils, fatty |
| | softener | | polypeptides, fatty | acid esters, |
| | | | acid esters, | carboxylic acids |
| | | | carboxylic acid | |
| F | Wax layer | 0-40 | 0-20 fatty acids, | 0-10, non-toxic |
| | destroyer | | (pelargonic acid | carboxylic acids, |
| | | | only in dosages of | Iron-containing |
| | | | 0-50% of the | metal soaps, |
| | | | amounts permitted | alkalized humic |
| | | | in PSM for the | materials |
| | | | respective culture) | |
| | | | Terpene oils, | |
| | | | alkalized humic | |
| | | | substances, iron- | |
| | | | containing metal | |
| | | | soaps | |
| G | Foam | 0-2 | 0-1 | 0-1 |
| | additives | | | |

For all experiments, standard chemical herbicide (glyphosate, pelargonic acid), or standard physical/mechanical (haulm topping, shallow cultivating, hoeing) practices still allowed are carried as positive controls. Negative controls are always completely untreated strips. In addition, one strip at a time is treated with only the contact resistance lowering medium and one with only the electric current, respectively, to demonstrate the synergy of the two method components.

The experiments are run with 6-9 m wide equipment, with the working width of the individual electrophysical treatment units being 50 cm or 1 m. In any case, 1 m wide strips are always treated identically. To exclude edge effects, the middle 50 cm of each 1 m wide strip is always evaluated over a length of 6 m.

For each treatment, three repetitions are normally provided, and five in the case of irregular growth.

Each experiment track, which can be run in one piece, contains a sequence of treatment units in which the speed is kept constant for as long as possible and is only changed in blocks. Within each experiment track, parameters such as the maximum tension, the maximum output per meter of working width and the application volume are changed before another speed is tested.

Since manual modifications to the experimental unit are necessary to change applicators, application equipment positions (front, rear) and to switch between transition resistance lowering media (different composition, different concentrations), such changes can only be carried out on different experimental tracks.

Between each individual treatment there are non-evaluable buffer areas of 10 m length, in which the corresponding parameters on the spraying unit and electrophysical treatment are changed over. The changeover is either manual, but ideally GPS-controlled, assisted or completely automatic by the control unit of the overall system.

Only the two 2-3 m strips to the right and left of the tractor are evaluated in each case. The areas overrun by the tractor tires are basically excluded. The area between the tractor tires is used for zero checks and positive checks. Since the application of classic herbicides requires completely different spraying systems, these are done by a separate tractor with appropriate spray booms, which sprays only the areas directly behind the tractor, creating the tracks for later treatment. To eliminate any drift problems, the spray units are always placed in the transition areas. More than one type of spray control can be created because, for example, when using potato herbicides, but also glyphosate, farmers also do not always spray with a uniform dose. Here, the efficiency then becomes comparable with the various conventional dosages. The spray tractor for the control drives just before the transition resistance lowering treatment. The area rolled over by the tractor tires and the area outside the tractor tires with up to 3 m total width then serves as a buffer strip to catch drift effects; this is not evaluated.

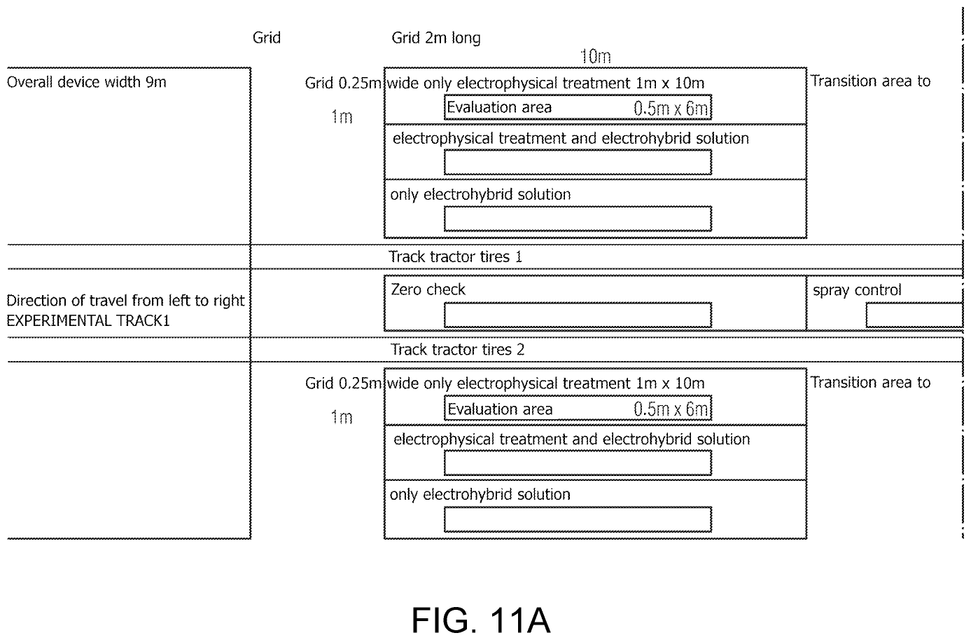

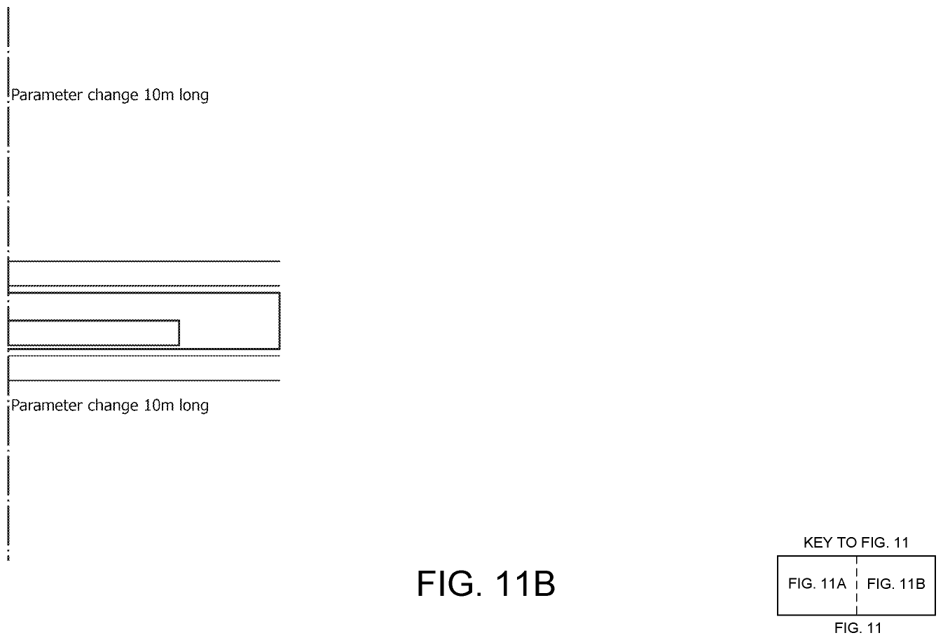

FIGS. 11A and 11B show a section of an experimental plan for carrying out a method according to the invention in an agricultural field. Here you can see a web width corresponding to 9 m working width of the tractor, a treated section (center) and a transition section (right).

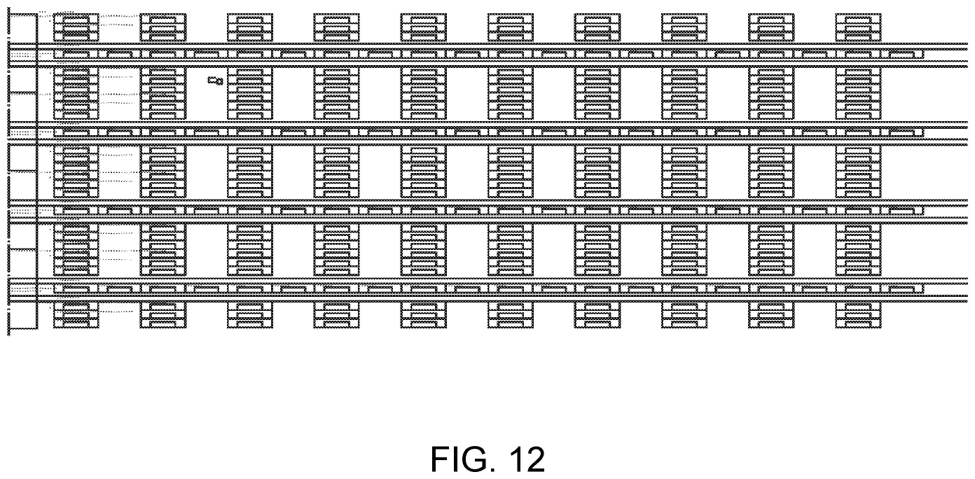

FIG. 12 shows an experimental field section with a large number of plots, which are divided among the respective experimental members according to the rules mentioned in the text. Shown are 4 experiment tracks, each with 10 treatment units in a row.

The experiments carried out and their results are described below. In this context, the substance mixture for increasing the effect of electric current applied to plants is also referred to as a medium lowering the electrical contact resistance or as a liquid.

### Experiment 1: Treatment of Grain

Properties of the Experiment Field:

The experimental field is located on the outskirts of Wanlo in North Rhine-Westphalia, Germany (51° 05′56.3 ″N 6° 25′18.8 ″E). The soil type is described as parabrown earth. According to the mapping instructions of the Geological Survey of North Rhine-Westphalia, the material is clayey silt. The estimate of the value figure is very high at 75-85. The dry soil becomes very hard and shows massive dry cracks already in late, dry spring.

Experimental Design:

A vehicle, namely a tractor, with a device according to the invention was used for the treatment of grain. A field sprayer with a working width of 6 m was attached to the front of the tractor as an application apparatus. At the rear of the tractor was the application apparatus for applying electricity. In this case, the power generator was driven by the PTO and had an output of up to 72 kW. 20 high-voltage units, each with 3.6 kW power, provided the nominal power in a voltage range between 2000 and 5000 V. The device worked on 6 m width (working width). The application apparatus used was classic long applicators (also known as tongue applicators or LRBs) made of sheet metal leafs with 60 to 80 cm pole spacing, which were mounted across the entire working width. Tongue applicators were used as one pole and cutting discs in the bottom as the second pole.

The treatment was tested in green wheat because it is a crop with very homogeneously growing, closely spaced plants. The plants are also upright, in such a manner that it is possible to introduce the current only into the leaves of the plants without further ado. In addition, grain represents a challenging application due to its robustness. At the time of treatment, ear emergence was already complete. At this point, for physiological reasons, rapid and complete killing of monocotyledonous plants with electricity alone is hardly possible, since lignification of the stems is already largely complete.

For the experiment, one track length (excluding headland) of each track of the experimental field was divided into five sections for four different speeds (in increasing order) and for one control without power (also referred to as liquid control or spray control). The sections each had a length of at least 10 m or, for 2 km/h and 4 km/h, of at least 20 m.

The sections were then treated according to the experimental design, first with water or different liquids (water with addition of Cocktail, Hasten, Polyaktiv or Bolero) and after a very short exposure time (approx. 4-8 s) with electricity using the tongue applicators. For the control without current, the corresponding sections were treated only with the respective liquid. A control without liquid or water, in which the plants were treated with electricity only (dry), was also included. Four different tractor travel speeds, 0.5 km/h, 1 km/h, 2 km/h, and 4 km/h, were used for the stream treatment, resulting in four different nominal inputs of electrical energy (see Energy Input and Tractor Speed section). The liquid application rate for applying the different liquids was 400 l/ha.

Completely untreated strips of the experimental field stretched the entire length of the experimental field as a control (untreated; also referred to as zero control), parallel to the treated tracks or strips.

Liquids (media lowering the electrical contact resistance):

The additives used for the liquids Cocktail, Hasten, Polyaktiv and Bolero are commercially available products. The names of the additives essentially correspond to the proper names of the commercial products. For each of the liquids, the additives were used in water at the concentration specified by the manufacturer.

Cocktail (manufacturer Lotus Agrar GmbH, Stade, Germany) is marketed as an additive for herbicides. Cocktail is a mixture of 60% ethyl oleate from sunflower oil and 40% sugar derivatives.

Hasten (manufacturer ADAMA Deutschland GmbH, Cologne, Germany) is a mixture of rapeseed oil ethyl esters and rapeseed oil methyl esters and nonionic surfactants (716 g/l rapeseed oil ethyl and methyl esters, 179 g/l nonionic surfactants). Hasten is formulated as an emulsion concentrate and marketed as an additive for herbicide treatment.

Polyaktiv is the commercial product Lotus Polyactiv Zn (manufacturer Lotus Agrar GmbH, Stade, Germany), which is on the market as an additive for foliar fertilizers. Polyactive has 10.8% (150 g/l) zinc and 13.5% (185 g/l) sulfuric anhydride (SO3). More important in the present case, however, is the formulation of Polyaktiv, which is made with polyols (also called sugar alcohols). Polyactive is a polyol-zinc complex.

Bolero (SDP Bolero, manufacturer Lotus Agrar GmbH, Stade, Germany) is marketed as an additive for foliar fertilizers. Bolero has 9.5% (120 g/l) boron. However, more important is the formulation of Biolo, which is undertaken with polyols (also called sugar alcohols). Biolo is a Polyol-boron complex.

The liquid application rate of 400 l/ha for wheat after ear emergence was determined in a preliminary experiment in which volumes between 200 and 800 l/ha were tested. Here it was shown that from an application volume of 400 l/ha, the electrical resistance (corresponding to 1 bar for the type of nozzle used) leveled off at approx. 7000-8000 ohms and compared strongly with the strongly fluctuating 12000-22000 ohms when the plants were treated in dry condition.

Energy Input and Speed of the Tractor

The energy input is also referred to here as energy input. In addition to the total power available, the real energy input also depends considerably on the current resistance of the plants and, if necessary, of the soil, since the voltage supply units can only operate at full power between 2000 and 5000 V. Accordingly, the real energy input per hectare at high resistance can be significantly lower than the nominal energy input calculated at full power.

Depending on the speed of the tractor, the following nominal inputs of electrical energy per hectare are obtained when using the long applicators in cereals:

0.5 km/h: 30 kW/ha

1 km/h: 60 kW/ha

2 km/h: 120 kW/ha

4 km/h: 240 kW/ha

Objectives of the Experiment:

The experiment served to compare a treatment by means of the process according to the invention (crop.zone treatment) with a treatment only with electricity (i.e., without liquid) as well as with a treatment only with liquid (i.e., without electricity).

The experiment further served to compare different liquids, each at different nominal inputs of electrical energy (different speeds of the tractor).

Experimental Evaluation:

Only the areas not flattened by the tractor's tires up to a maximum of 30 cm from the outer edges of the working width were used for the experimental evaluation.

The results of the treatment were visually bonitted and plotted by a drone with NDVI measurement one week after treatment. NDVI stands for Normalized Difference Vegetation Index. It is the most commonly used vegetation index. Similar bondings were summarized in NDVI classes (green value classes). An increase in the NDVI class which was set for the untreated control 1 corresponds to a reduction in the green value.

Experimental Results:

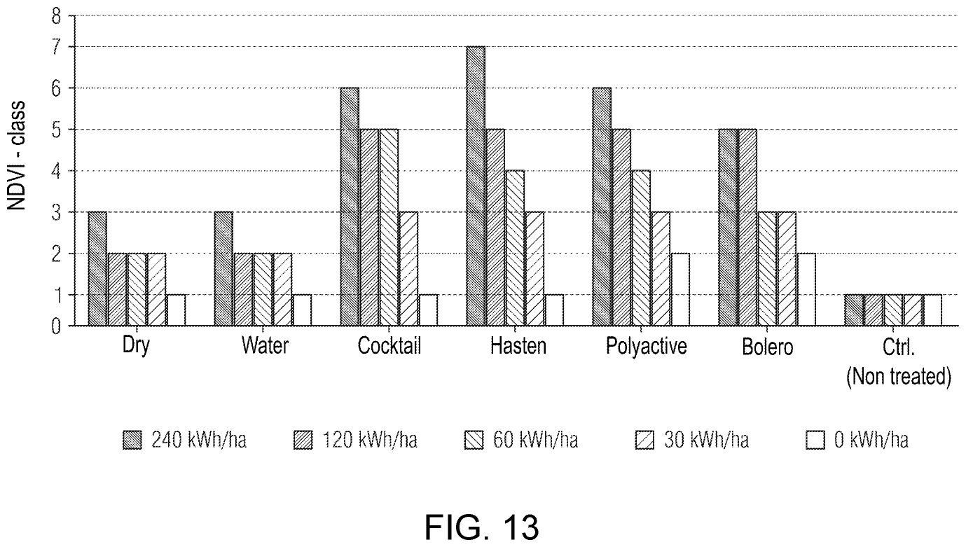

FIG. 13 shows the classification of the NDVI reflections of the drone images of the crop field into seven intensity classes, with class 1 corresponding to the highest green value and class 7 corresponding to the lowest green value. The NDVI class 1 was set for the untreated control. The figure shows the results of treating the plants with water or different liquids (water with the addition of Cocktail, Hasten, Polyactive or Bolero) and then with electricity. In addition, the results of the following controls or comparative treatments are shown: (1) “Contr. (untreated)” is the untreated control; (2) “Dry” is the control without liquid (stream only); (3) plots each with 0 kWh/ha are the controls without stream (water or liquid only). The specific energy specifications represent the nominal input of electrical energy per hectare. The real input of energy can be lower if the resistance of the high-voltage units is no longer working at full load.

The liquids used (water with additives as indicated) do not themselves have herbicidal activity. They have been developed to enhance the effect of chemicals on plants. Chemical action refers to the action of pesticides, such as herbicides, and foliar fertilizers, which are designed to better penetrate plants and then either kill them or fertilize them. In contrast, electricity does not have chemical compounds that could penetrate plants. The liquids used therefore originate from a different field of application and were actually only intended by the inventors for initial screening for more complex electrical contact resistance-lowering media. That the liquids used in combination with the application of electricity would show such a large synergistic effect was in no way expected, since the mechanism of action of electrophysical treatment of plants with electricity is fundamentally different from the mechanism of chemical treatments with pesticides and foliar fertilizers.

The results show that, except for the extremely high value of 240 kWh/ha, the treatment of the plants with electricity in dry condition and with previous treatment with water differed from the untreated control by only one green value class and no bonitable differences were discernible among themselves. The reduction in green value at 240 kWh/ha for treatment with electricity in dry condition and with previous treatment with water is equal to that of all treatments with the different liquids at 30 kWh/ha. This means that the biological effect becomes 8 times more efficient by using the liquids.

The results show that treatment only with the liquid, i.e., without electricity (0 kWh/ha), had no effect on the green value of the cereal plants in the case of Cocktail and Hasten as additives. In the case of Polyaktiv and Bolero as additives, there was a slight effect (increase by one green value class). With the additional treatment with current, a decrease in the green value occurred in all liquids, in a dose-dependent manner: An increase in the amount of energy used showed an increase in the effect dependent on the dose of the amount of energy used. Thus, a dose-active relationship is present.

Treatment only with electricity, i.e., without liquid or water, showed only a small effect with regard to the reduction of the green value (control “Dry”, increase only by one green value class or at 240 kWh/ha by two green value classes). Based on the “Dry” control, it can be seen that cereals are a challenging application for siccation treatments due to their robustness. The treatment only with current corresponds to the prior art. In this case, very high amounts of energy (240 kWh/ha and more) are required to achieve an effect, which is practically unfeasible given the tractor power available electrically in the fields.

The effect obtained with treatment only with electricity at 240 kWh/ha (control “Dry”) is surprisingly achieved with the additional use of the liquid (cocktail, Hasten as an additive) already at 30 kWh/ha (achieving green value class 3). Thus, by combining it with the liquid, only one-eighth of the amount of energy is required for the same effect compared to the current treatment alone. This allowed the tractor to travel at 4 km/h for the same effect with the combination of liquid and current, while it had to travel at 0.5 km/h for this with the control without liquid. The reduction in the amount of energy required by a factor of 8 through the combination of liquid and electricity is far beyond expectations in the field of plant treatment, since an improvement by a factor of 2 is already considered exceptional for purely chemical plant treatments.

Reducing the amount of energy required by a factor of 8 by combining liquid and electricity makes the treatment practical to implement given the tractor power available in the fields electrically. In addition, the desired effect can be achieved at a higher speed of the tractor, in such a manner that the time required to treat the plants is reduced.

However, the combination of the treatment with the liquid and the treatment with the current not only significantly reduced the energy requirement, but surprisingly also significantly increased the effect on the plants, up to the green value class 6, or even up to the green value class 7 in the case of Hasten. Thus, the combination significantly increased the efficiency of the treatment.

The liquids have surface active and wax layer softening ingredients. Hasten showed the best effect as an additive, followed by Cocktail and Polyaktiv. The increase in efficiency demonstrates the importance of wetting and softening the leaf surface for electric current penetration.

Treating the plants with water instead of a medium lowering the electrical contact resistance before current application showed no effect compared to treatment with current only (same result for “water” and “dry”).

The measurements of current and voltage have shown that by using the liquids compared to the treatment in dry condition, the voltage can be reduced from 3600 to 2800 V on average for the same power. This corresponds to a reduction of the electrical resistance by approx. 20%. Further optimization of the liquids is expected to result in further voltage reductions. Low resistances and voltages are also critical for cost-effective production of application apparatus and effective safety-related configuration of the same. Furthermore, the effect of the electric current increases with decreasing resistance or increasing currents for the same total amount of energy.

The results show that the contact resistance between the applicator and the plant can be reduced by about 20% after a very short exposure time (about 4-8 s) by using media that lower the electrical contact resistance, especially wax layer softening and wetting liquids. However, the biological effects of current application increase up to 8-fold for the same (low) effect level if a medium that lowers the electrical contact resistance is used instead of using pure water or treating the plants in a dry state. Without such a medium, no relevant siccation of grain could be achieved even at very high energy intensities (240 kWh/ha) when using pure water or treating the plants in dry condition. However, after addition of the medium, which itself has no herbicidal effect, massive chlorophyll loss and incipient siccation could be observed.

The results show that, in terms of treating the plants with electricity, the use of a medium that lowers the electrical contact resistance is the decisive effect compared to the use of pure water or treating the plants in a dry state. What has been shown here using grains as an example can easily be applied to a wide variety of other plants.

### Experiment 2: Treatment of Potatoes

Properties of the Experiment Field:

The field is located at Peringsmaar/Bedburg in North Rhine-Westphalia, Germany (50° 59′37.5″N 6° 35′21.0″E). The area is a recultivation area of the open-cast lignite mine there. Accordingly, the soil type is described as order pararendzina. According to the mapping instructions of the Geological Service of North Rhine-Westphalia, the soil is silty clay. The reclamation was done about 15 years ago. Nevertheless, the soil falls due to a very low microbial decomposition activity, for example for grain straw. However, for the potatoes, the soil offers exceptionally good growth conditions compared to nearby grown soils. Despite the hot and dry summer, the field used was the only non-irrigated potato field in the region that was still completely green at the time of siccation. The estimate of the value number is high at 45-75.

Experimental Design:

For the treatment of potatoes, a vehicle, namely a tractor with hoe tires, was used with a device according to the invention. A spraying apparatus (field sprayer) with a working width of 6 m was attached to the front of the tractor as an application apparatus. The spraying apparatus could be parked on one half of the field, depending on the experiment target, resulting in experiment plots 3 m wide and 10 m long. Spraying of liquid was done about 10 m before applying current. For applying the current, an application apparatus for applying current was mounted at the rear of the tractor. In this case, the power generator was driven by the PTO and had an output of up to 72 kW. 20 high-voltage units, each with 3.6 kW power, provided the nominal power in a voltage range between 2000 and 5000 V. The device worked on 6 m width (working width).

For applying the current, an application device for applying current was mounted at the rear of the tractor. At the time of treatment, the potato plants were in phenological stage 81 (81-83), i.e., still vigorously green. The Challenger variety is generally considered to be vigorous and difficult to siccate. The hot and dry summer generally led to an increased formation of wax layers.

The tractor travels between the 3./4 and 5./6. Dam crest. Only the rows 3 and 5 are used for the experimental evaluation. The individual experiment plot sections, which were treated at different tractor speeds, were separated by holding and acceleration areas. The individual experiment plots were partially randomized, since only such surface arrangements can be driven over with a 6 m working width device at three different speeds.

Based on the unexpected success of combining liquid and current in cereals (experiment 1), a wetting agent well established in potato (Cantor, HL1) was tested in combination with the application of current, and a conductivity-increasing salt solution was added to the wetting agent as a further variant (HL2). For this purpose, the sections were first treated with the different liquids (HL1, HL2) according to the experimental plan and, after a very short exposure time in the range of a few seconds, with electricity. For the control without current (liquid control), the corresponding sections were treated with liquid HL2 only. Three different travel speeds of the tractor, namely 2 km/h, 4 km/h and 6 km/h, were used for the electric power treatment, resulting in three different nominal inputs of electric power. The liquid application rate for applying the different liquids was 150 l/ha (nHL) for part of the experiments, while it was 300 l/ha (HL) for another part of the experiments and for the liquid control.

Single treatments and double treatments, each with the combination of liquid and current described above, were performed. In the double treatments, the second treatment took place 1 week apart from the first treatment. There was also a part of the experiment where the second treatment was a purely chemical treatment with Shark (1.0 l/ha) instead of a liquid and current treatment.

The first liquid HL1 used in the experiment was the approved additive Cantor at a concentration of 0.15%, since the potatoes were to go to the open market. Kantor is a commercially available product. The name is the proper name of the commercial product. Kantor is based on an alkoxylated triglyceride technology and is marketed as an additive to safeguard the efficacy of crop protection products (manufacturer agroplanta GmbH & Co. KG, Zustorf, Germany). Kantor is formulated as a liquid active ingredient concentrate and acts as a wetting agent. In addition to the alkoxylated triglycerides, Cantor has 1-10% acetic acid and 1-10% D-glucopyranose, oligomers, decyloctylglycosides. For the second liquid HL2, magnesium sulfate (magnesium sulfate heptahydrate, also known as epsomite, MgSO4*7H2O, manufacturer e.g., K+S KALI GmbH, Kassel, Germany) was added to HL1 at a concentration of 1 kg/100 L liquid.

Completely untreated experimental plots were included as controls (untreated; also referred to as zero controls). As a further control, a purely chemical treatment of the plants (Quick/Shark; also referred to as Quickdown/Shark or as a positive control), that is, without liquid HL and without electricity, was included. The purely chemical treatment (siccation) was carried out with Quickdown 0.8 l/ha+Toil 2.0 l/ha and seven days later, i.e., one week apart, with Shark 1.0 l/ha (Quickdown: 24.2 g/l pyraflufen (wt. % 2.4), Belchim Crop Protection Deutschland GmbH, Burgdorf, Germany; Toil: 10% Coco Diethanolamide, Cheminova Deutschland GmbH & Co. KG, Stade, Germany; Shark: 55.92 g/l Carfentrazone (60 g/l ethyl ester), Belchim Crop Protection Deutschland GmbH, Burgdorf, Germany). The names are the proper names of the commercial products. The application rates of the substances and water correspond to the professional standard treatment for chemical potato siccation and were determined and carried out in this way by an expert for potato siccation from the Rhineland Chamber of Agriculture.

The experiments with the different liquids took place on three tracks next to each other. Only the purely chemical control treatments and the zero control were on an additional fourth lane, which was directly adjacent to the third lane.

Due to space and expense constraints, only two replicates could be performed per treatment. A total of 41 experimental links (different plot treatments) were made in two replicates.

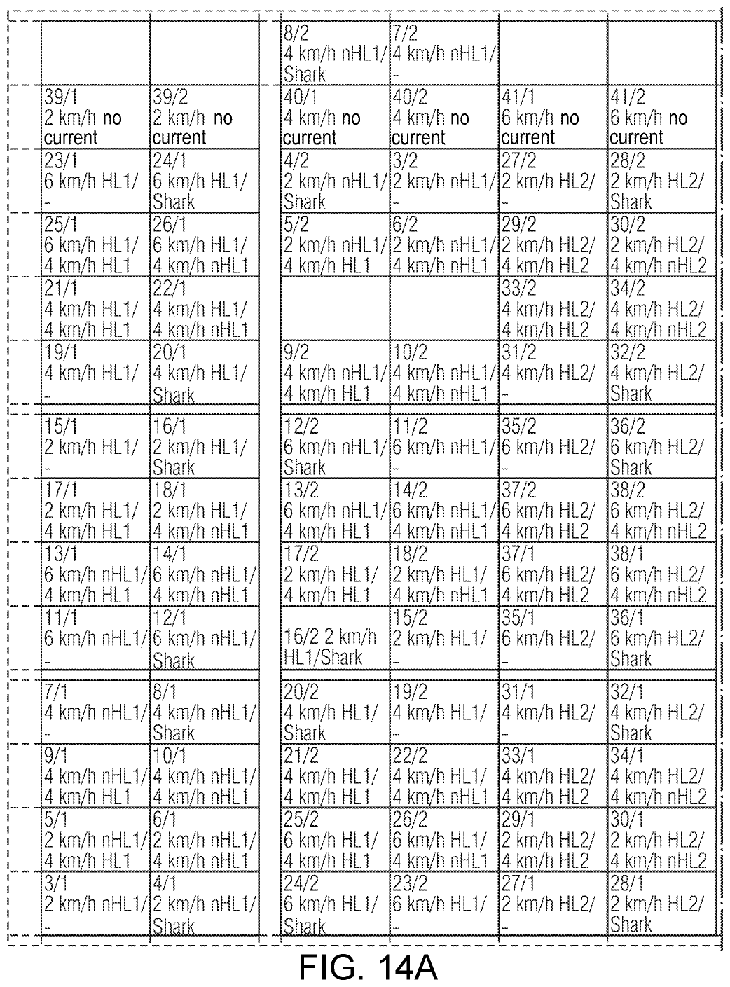

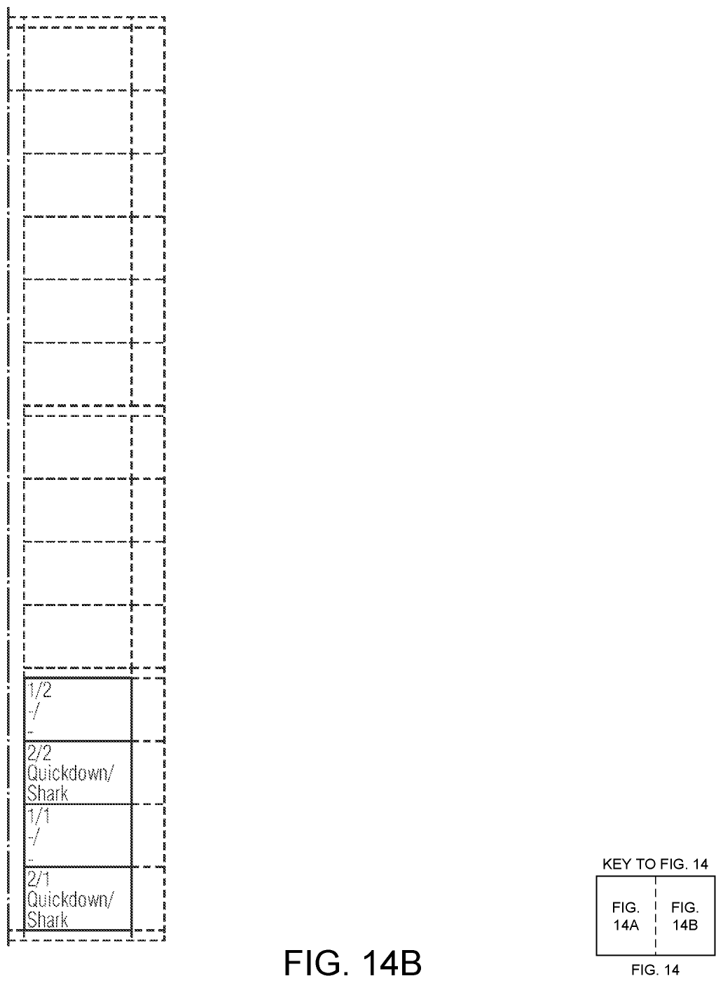

FIGS. 14A and 14B show the experimental arrangement, i.e., the arrangement of the experiment elements on the field. The plot size was 3×10 m. HL1 and HL2 denote the different liquids. nHL stands for the low liquid application rate of 150 l/ha and HL for the high liquid application rate of 300 l/ha. Two treatments were performed 1 week apart (first treatment/second treatment), and the second treatment could also be a purely chemical treatment (Shark) or, in the case of a single treatment, omitted (−). The chemical-only control treatments (Quickdown/Shark) were on an additional strip on which the untreated controls (−/−) were also located.

Energy Input and Speed of the Tractor

The energy input is also referred to here as energy input. In addition to the total power available, the real energy input also depends considerably on the current resistance of the plants and, if necessary, of the soil, since the voltage supply units can only operate at full power between 2000 and 5000 V. Accordingly, the real energy input per hectare at high resistance can be significantly lower than the nominal energy input calculated at full power. The real energy input may be lower, especially for the second crossing, which took place one week after the first crossing, when the resistance of the partially dried plants is so high that the power supply can no longer operate in the working range of full load (2500-5000 V). Accordingly, the speed is referred to in the description of the experiment.

Depending on the speed of the tractor, the following nominal inputs of electrical energy per hectare are obtained when used in potatoes:

2 km/h: 48 kWh/ha

4 km/h: 24 kWh/ha

6 km/h: 16 kWh/ha

Objective of the Experiment:

The experiment was used to compare two different media (liquids) that lower the electrical contact resistance and two different application rates of a liquid, in each case with different nominal inputs of electrical energy (different speeds of the tractor).

Experimental Evaluation:

For the experimental evaluation, all plots were photographed individually 1-2 times per week (each dam individually longitudinally 10 m, NIKON D7000 resolution 12 MP). Here, only the data three weeks and 20 days after the first treatment were evaluated. The 3-week period results from the general scheduling scheme of siccation treatments.

The images of the 10 m plots were evaluated visually. In each case, the stems were classified into the color classes gray, yellow and green. The gray color class contains both completely dried up/brittle stems and those that were so brown and tough that complete withering was only a matter of time with no possibility of re-sprouting. Yellow stems were not yet completely dead, had no, green or yellow leaves and could also still lead to resprouting. Green stems did not have, yellow or green leaves. In the experimental parts where resprouting was bonitized separately, it consisted of small leaves (max. 2 cm in size) emerging directly from the stems. An average of 81 stems per plot was evaluated, for a total of 6643 potato stems.

Experimental Results:

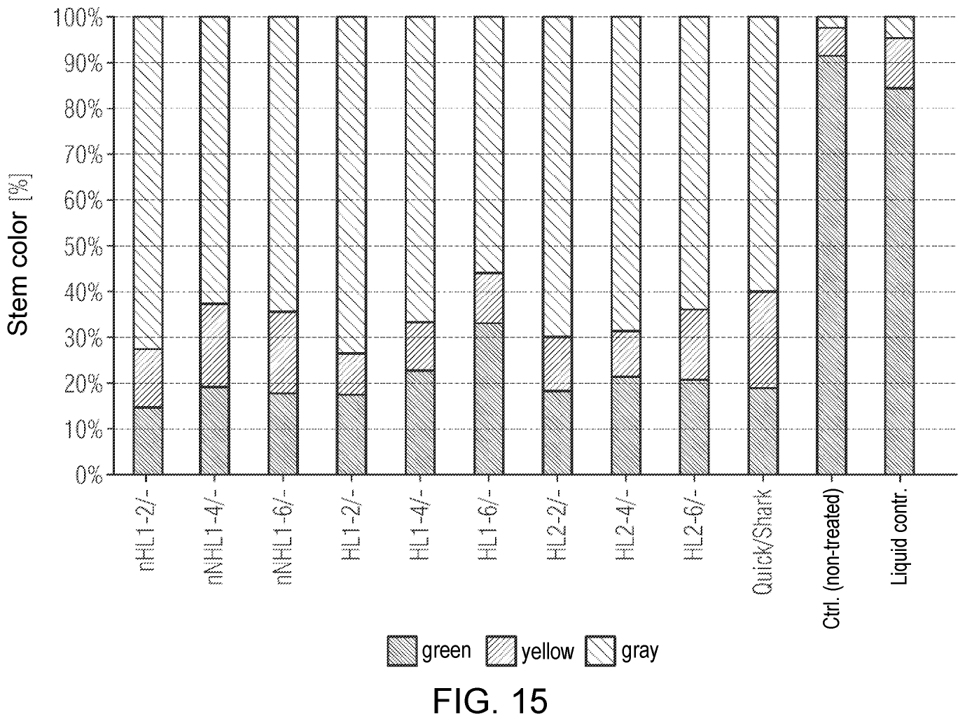

FIG. 15 shows the results of individual treatment of potatoes with liquid HL1 or HL2 and with electricity. The figure shows the percentage of green, yellow and gray stems 20 days after the first crop.zone treatment. In the crop.zone treatment, the field sections were first treated with liquid HL1 or HL2 and, after a very short exposure time in the range of a few seconds, with electricity. Compared HL1 and HL2 liquids at low (nHL) and high (HL) application rates (liquid application rate) with single application of crop.zone treatment at different speeds (2, 4, and 6 km/h, labeled −2, −4, and −6, respectively, in the designation) compared to positive control (Quick/Shark), control without treatment (untreated), and liquid control (liquid contr.).

Interestingly, the use of a higher nominal energy per ha at 2 km/h (48 kWh/ha) showed only slightly better desiccation than 16 kWh/ha (6 km/h), regardless of the liquid used. The highest efficacy was found at 2 km/h for low volume (nHL1) and high volume including conductivity component (HL2). The best average effectiveness for all speeds was achieved with HL2. Accordingly, the use of an electrically conductive component in the liquid is advantageous.

Also, the pure chemical double treatment (Quick/Shark) was not more effective than the single crop.zone treatment. The observed limited efficiency of the purely chemical treatment despite the optimal weather for the substances in the experiment period (a lot of sun and drought) corresponds to the gap in effectiveness that occurred after the ban of Reglone (Diquat) or after its approval ended due to toxicity against so-called “bystanders”. This gap in effectiveness is an important reason for the need for the process according to the invention.

The simple crop.zone treatment on green plants of hard-to-siccify potato varieties such as Challenger at higher speed (6 km/h with only 16 kWh/ha of electrical energy) with HL2 results in effective canopy opening (replaces Reglone): For a better siccation result, the crop.zone treatment can be integrated into a two-step siccation. A two-stage siccation treatment also corresponds to the usual chemical double treatment and the associated gentle, gradual initiation of the ripening process of such potato varieties.

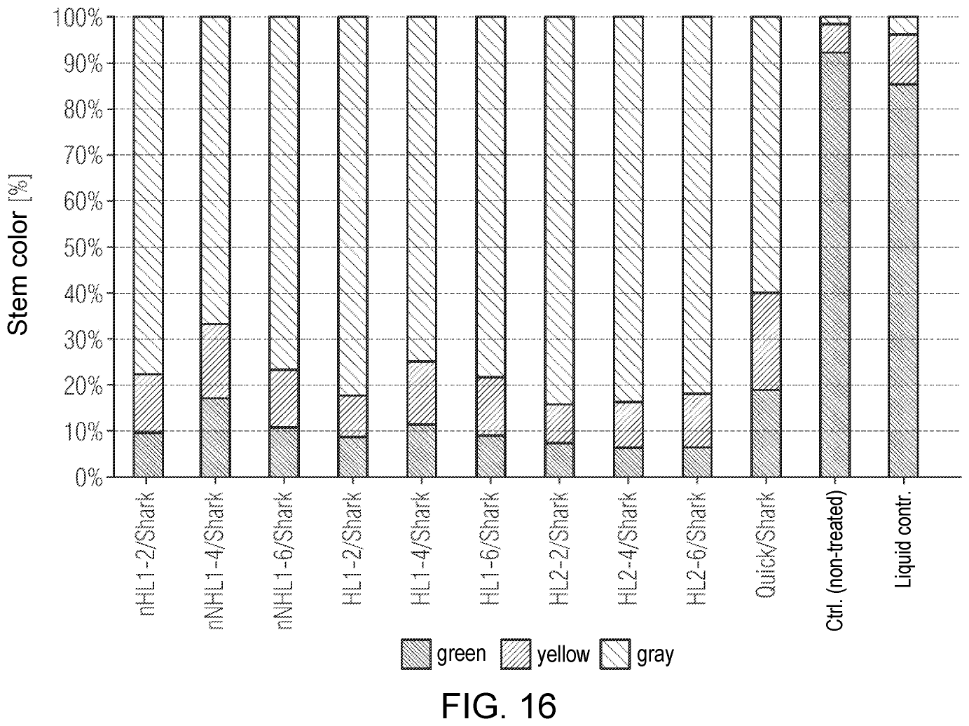

FIG. 16 shows the results of the single treatment with liquid HL1 or HL2 and with current in combination with a chemical secondary treatment. The figure shows the percentage of green, yellow and gray stems 20 days after the first crop.zone treatment. In the crop.zone treatment, the field sections were first treated with liquid HL1 or HL2 and, after a very short exposure time in the range of a few seconds, with electricity. The liquids HL1 and HL2 are compared at low (nHL) and high (HL) application rates (liquid application rate) with a single application of the crop.zone treatment at different speeds (2, 4 and 6 km/h, labeled −2, −4 and −6, respectively, in the designation) in combination with Shark as a chemical secondary treatment (reapplication) in comparison with the positive control (Quick/Shark), the control without treatment (untreated) and the liquid control (liquid contr.).

The results show that in the case of the chemical secondary treatment, the stems were dried out (grayed) about 10-20% better than after a single treatment (FIG. 15). Both treatments with HL1 (low and high volume of liquid) show their lowest efficacy at 4 km/h for unknown reasons but reproducibly, while HL2 at high volume (low volume not tested) shows the highest and almost constant efficacy (highest amount of gray stems) at all three speeds.

Compared to the purely chemical positive control (Quick/Shark), the efficacy of the crop.zone treatment was about 30% higher. This underlines the high efficacy of the crop.zone treatment compared to Quickdown, which replaces Reglone especially in the siccation of still completely green potatoes. The crop.zone treatment is significantly more efficient than Quickdown as an initial treatment. The crop.zone treatment at higher speed (6 km/h, 16 kWh/ha) using a well conducting liquid in combination with a secondary treatment with Shark already resulted in an effective siccation better than the pure chemical double treatment (Quick/Shark).

Visual boning revealed that the remaining green stems and the majority of the yellow stems had an orientation across the direction of travel and reached primarily down into the valleys between the dams. Accordingly, the accessibility by the applicators is the reason for the residual stock of non-dried stems.

A third treatment or later timing of the second treatment may be beneficial to completely dry out the stems and minimize regrowth, especially if the potatoes were still completely green during the first treatment.

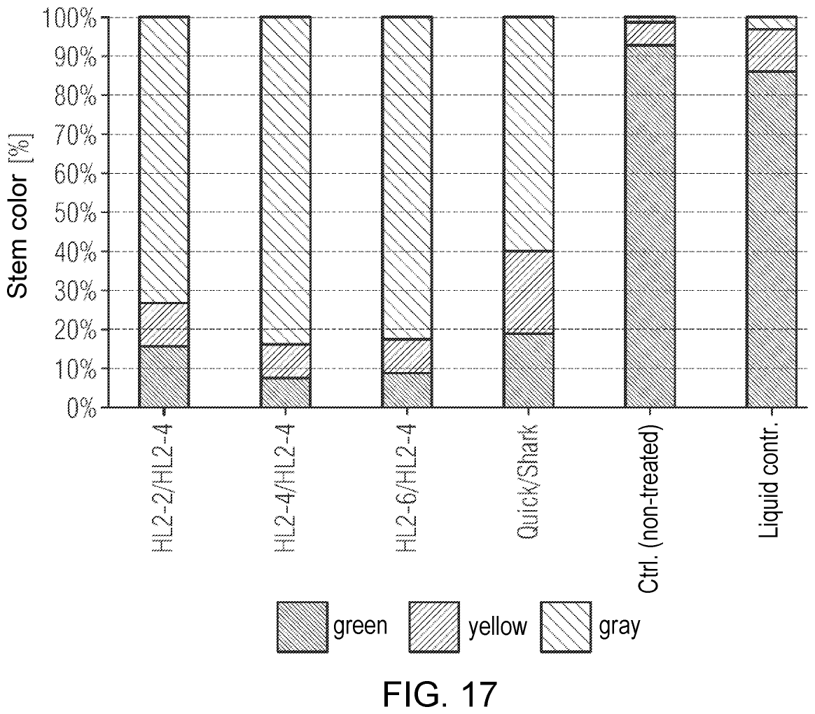

FIG. 17 shows the results of the double treatment, both with liquid HL2 and with current. The figure shows the percentage of green, yellow and gray stems 20 days after the first crop.zone treatment. In the crop.zone treatment, the field sections were first treated with the liquid HL2 and, after a very short exposure time in the range of a few seconds, with electricity. Compared the different speeds (2, 4 and 6 km/h, labeled −2, −4 and −6, respectively, in the designation) in the first treatment and a constant speed of 4 km/h in the second treatment in comparison to the positive control (Quick/Shark), the control without treatment (untreated) and the liquid control (liquid contr.).

The results show that the double crop.zone treatment dried out (grayed) the stems about 10% better than after a single crop.zone treatment.

Interestingly, the use of a higher nominal energy per ha at 2 km/h (HL2-2, 48 kWh/ha) did not show better desiccation than the use of 16 kWh/ha (HL2-6). A higher speed (6 km/h) instead of 2 km/h did not reduce the effectiveness.

As a result, the crop.zone treatment resulted in effective siccation even at high speed (6 km/h) of the initial treatment in combination with a second crop.zone treatment. Thus, the crop.zone treatment provides a completely non-chemical treatment to enable high quality and targeted organic potato production.

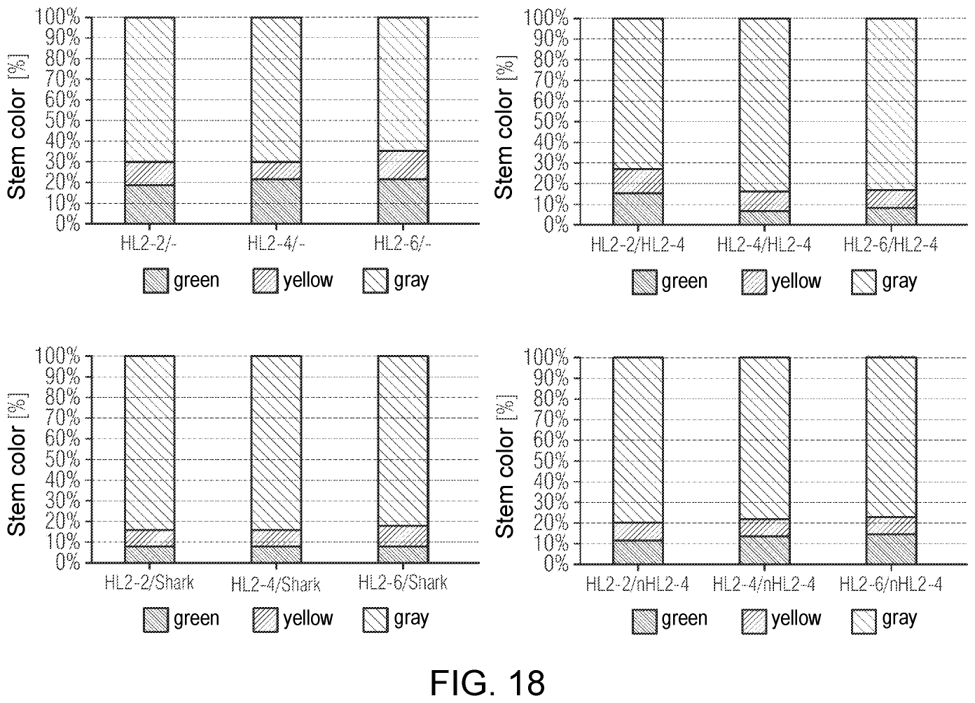

FIG. 18 shows the results of four different treatment patterns. The figure shows the percentage of green, yellow and gray stems 20 days after the first crop.zone treatment. In the crop.zone treatment, the field sections were first treated with the liquid HL2 and, after a very short exposure time in the range of a few seconds, with electricity. Compared are the different velocities (2, 4, and 6 km/h, labeled −2, −4, and −6, respectively, in the designation) at initial treatment for the four different treatment patterns. Top left: single crop.zone treatment with HL2. Top right: double crop.zone treatment with HL2 and constant 4 km/h in secondary treatment with high liquid application rate. Bottom left: crop.zone treatment with HL2 in combination with Shark as secondary treatment. Bottom right: double crop.zone treatment with HL2 and constant 4 km/h in secondary treatment with low liquid application rate. Since this presentation of results is only concerned with the small dependence of the siccation on the speed or the amount of energy used (factor 3, difference between 2 km/h and 6 km/h), controls were omitted here.

Despite halving the energy from 2 km/h to 4 km/h, only two treatments with low volume of liquid (nHL2) show slightly lower efficacy at 4 km/h in the second treatment, while high volume of liquid even shows higher efficacy. 6 km/h showed either no reduction in efficacy (double treatment with high volume) or only a slight reduction of maximum 5% in the other treatments.

In summary, the crop.zone treatment has a high potential for higher speeds (6 km/h and more) and lower energy to achieve adequate drying effects. This is true regardless of how the second treatment is implemented (crop.zone or chemical) after the physiologically important opening of the leaf canopy in the first treatment step.

Overall, the results of experiment 2 show that the addition of conductivity-increasing components such as magnesium sulfate to a wetting agent leads to a further improvement in siccation. By using the wetting agent and magnesium sulfate in the medium lowering the electrical contact resistance, the more constant and better results were obtained with a lower rate dependence of the effect of the medium.

The combination of treatment with a medium that lowers the electrical contact resistance and treatment with current allows a significant reduction in energy consumption compared to treatment with current alone. This is a crucial breakthrough technologically, as the tractor power available electrically is considerably limited, especially when using narrow hoeing tires in potato fields, and even when using tramlines, more than 120 kW of power is rarely available. Accordingly, only an application rate in the range of 30-50 kWh/ha allows a sufficient working width of the equipment (currently 6 m, in future 12 m or more) and an agronomically reasonable surface output of approx. 6-9 ha/h at a speed in the range of 6-8 km/h.

In comparison, haulm toppers (trial 3) typically operate at speeds of 8-12 km/h at 3 m working width, resulting in surface outputs of 2.4-3.6 ha/h and energy outputs in the range of approximately 8-14 kWh/ha.

In the experiment in cereals (experiment 1), a dose-response relationship of the crop.zone treatment was observed as a function of the amount of energy (dose) introduced. In contrast, in the experiments in potatoes, only a small dose dependence of the siccation (dependence of the siccation on the speed or the amount of energy applied) of the crop.zone treatment was observed. This was because the inventors did not sufficiently lower the amount of energy used for this purpose in the potato trials (i.e., they did not test higher tractor speeds such as 8 or 10 km/h). The reason is that the inventors did not expect such pronounced siccation effects to appear visibly after three weeks even at a speed of 6 km/h.

### Experiment 3: Treatment of Potatoes in Combination with Haulm Topping

The information on the characteristics of the experiment field, the experiment design and the energy input and speed of the tractor from experiment 2 also apply to experiment 3, except for some deviations in the experimental design. Only the deviations in the experimental design are described below.

For the experiment, a treatment strip of 300 m length was used on the same field, on each of which sections of about 100 m length were run at three different speeds and crop.zone treatment using liquid HL2 and a liquid application rate of 300 l/ha. In the crop.zone treatment, the sections were first treated with the liquid HL2 and, after a very short exposure time in the range of a few seconds, with electricity. Three different tractor travel speeds, namely 2 km/h, 4 km/h, and 6 km/h, were used for the electric power treatment, resulting in three different nominal inputs of electric power (see experiment 2). Haulm topping was carried out by the farmer using a standard weed whacker with a working width of 3 m and a working speed of approx. 10-15 km/h.

For the combined treatment experiment, the treatment strip with different dam application was driven on for the second time each 3 to 4 days apart with the tractor performing the crop.zone treatment (see experiment 2), with a haulm topper (two dams staggered), and again one dam staggered with the tractor performing the crop.zone treatment. This leads to the following four treatment combinations, where CZ stands for crop.zone treatment and HT for haulm topping:

CZ/CZ (double treatment with crop.zone),

CZ/HT/CZ (haulm topping between two crop.zone treatments),

CZ/HT (haulm topping after crop.zone treatment), and

HT (haulm topping only).

It additionally leads to an intermediate row that was not itself treated with crop.zone prior to haulm topping, but whose neighboring row was, and which also received partial treatment due to overhanging culms:

(CZ)/HT (haulm topping after a crop.zone partial treatment).

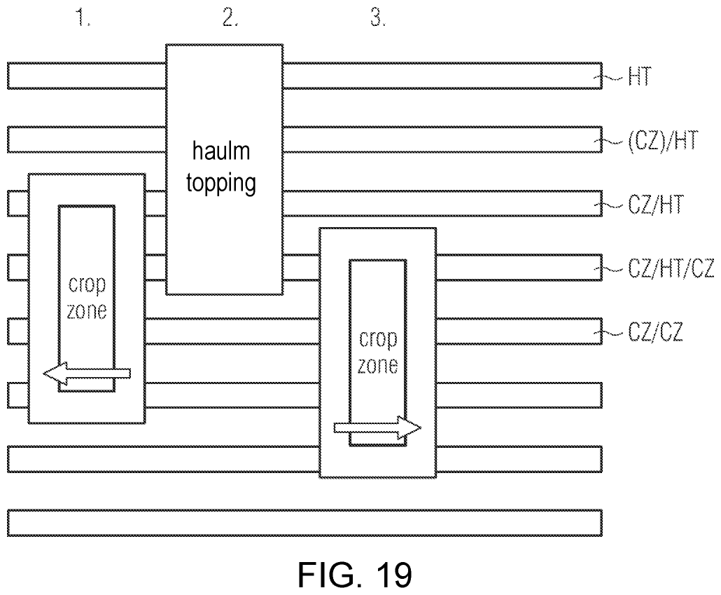

FIG. 19 shows the experimental arrangement just described.

Objective of the Experiment:

The experiment was used to compare four or five different treatment combinations, each at different nominal inputs of electrical energy (different speeds of the tractor).

Experimental Evaluation:

The experimental evaluation was performed as described for experiment 2. By visually classifying the stems (gray, yellow, green, resprouting (from green or yellow stems)), each of the stems on 20 m long sections (211-287 stems per sample, a total of 3807 potato stems) on 15 sections were evaluated here.

Experimental Results:

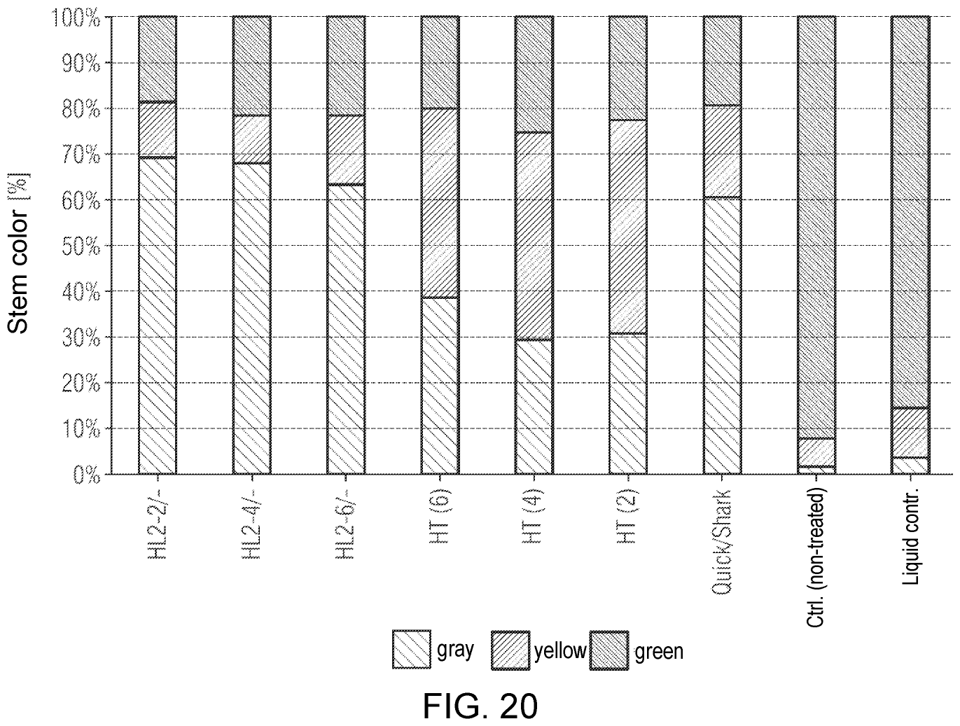

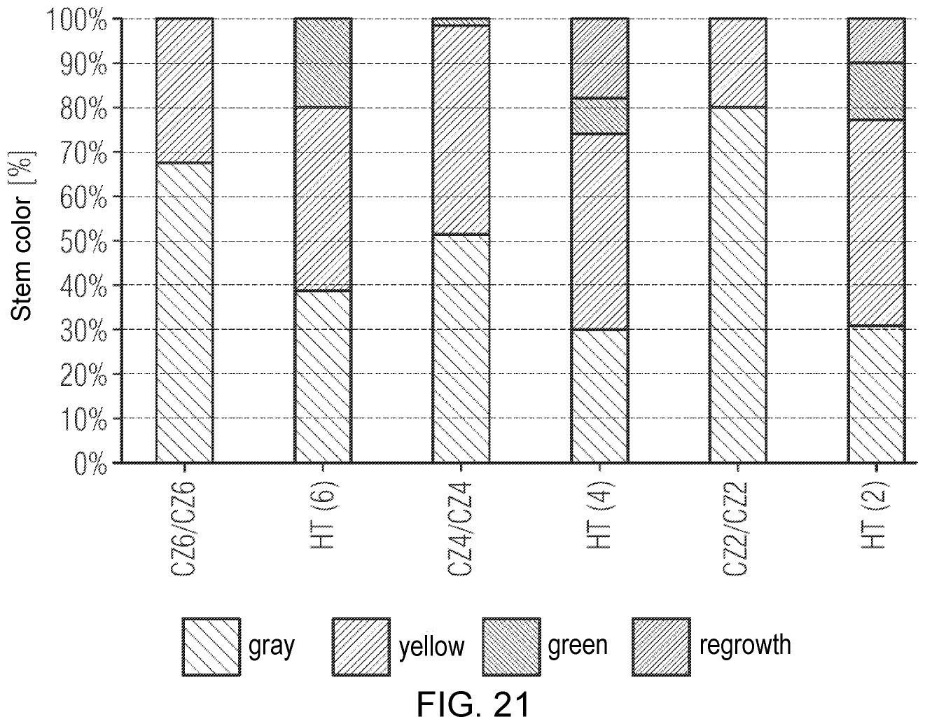

FIG. 20 shows the results of the crop.zone treatment of potatoes compared to haulm topping. The figure shows the percentage of green and restored culms and yellow and gray stems 20 days after the first crop.zone treatment. In the crop.zone treatment (CZ), the field sections were first treated with the liquid HL2 and, after a very short exposure time in the range of a few seconds, with electricity. Data from the single crop.zone treatment at three different speeds (2, 4, and 6 km/h, labeled −2, −4, and −6, respectively, in the designation) and the haulm strike (HT) alone in three replicates (2, 4, 6) of the positive controls (Quick/Shark), the control without treatment (untreated), and the liquid control (liquid contr.) were compared. Haulm topping alone (HT) was evaluated in parallel with crop.zone treatments in triplicate on potato ridges over a complete field length (300 m) in parallel, with replicates named only to the different speeds ((2), (4), (6)).

The main difference between replicates of haulm topping was the higher percentage of reappearance from yellow and green stems (up to 18% in replicate (4)), which are not shown in the graph because reappearance was not evaluated separately in the crop.zone treatment.

All single treatments and the pure chemical double treatment showed a remaining number of green stems in the range of 15-25% after three weeks. While haulm topping never showed more than 40% of dried gray stems, the single crop.zone treatment already showed 60-70% gray stems. The pure chemical double treatment showed 19% green stems and 60% gray stems, an effect below the single crop.zone treatment, which is an expression of the limited effect of the remaining chemical siccation agents even in optimal years with plenty of sunshine.

The single treatment with haulm topping or crop.zone was not enough to dry out vigorous green potato plants. Herbaceous batting alone showed the least desiccation of stems even in the fairly dry year of the experiment. Open stem ends after haulm topping and the regrowth triggered by haulm topping even in the fairly dry year poses an additional risk for viral infections from aphids and for other diseases.

Based on these results, for opening the leaf canopy, the crop.zone treatment is more effective than haulm topping. A double treatment with crop.zone without haulm toppers or a combination of crop.zone treatment with a chemical secondary treatment is the better choice for vigorous varieties compared to the use of haulm toppers.

FIG. 21 shows the results of the crop.zone double treatment compared to haulm topping. The figure shows the percentage of green and resprouted (re-sprouting) culms and yellow and gray stems 20 days after the first crop.zone treatment. In the crop.zone treatment (CZ), the field sections were first treated with the liquid HL2 and, after a very short exposure time in the range of a few seconds, with electricity. Data from the two crop.zone treatments at three different speeds (2, 4, and 6 km/h, labeled 2, 4, and 6, respectively, in the designation) from experiment 2 (same direction of travel) were compared with data from the haulm strike (HT) experiment (crop.zone treatment in opposite direction of travel).

While in one series of experiments the direction of travel of the second treatment was opposite to the first treatment, in the other series of experiments the direction of travel was in the same direction as the first treatment. While in the experiment with the opposite direction of travel the speed for the first and the second travel was always similar (2, 4 or 6 km/h), in the experiment with the same direction of travel only the speed for the first travel varied, and the second travel was always at 4 km/h.

The percentage of gray stems was higher or similar for the same direction of travel (more double treatment of the same stems) compared to travel in the opposite direction. In contrast, the opposite direction of travel showed almost no remaining green or regrowth stems, as all stems were electrically flushed at least once. This resulted in a dosage distribution that only at 2 km/h (the highest energy level, 48 kWh/ha) results in sufficient dosage to cause about 80% of the stems to turn gray. At higher speeds, more yellow stems remained, which had not yet completely dried out during the experimental period, but were also not relevantly resprouting. The highest percentage of yellow stems at 4 km/h is attributed to the fact that soil or microclimate conditions in the center of the field provided even more water here, resulting in slower drying. The phenomenon was observed to be even more pronounced in the haulm-only experiment along the entire length of the field.

As a result, it remains to be noted that safe contact of as many stems as possible by the application apparatus is important, even with the additional use of liquids, and that an opposite pass during secondary treatment further improves the siccation success.

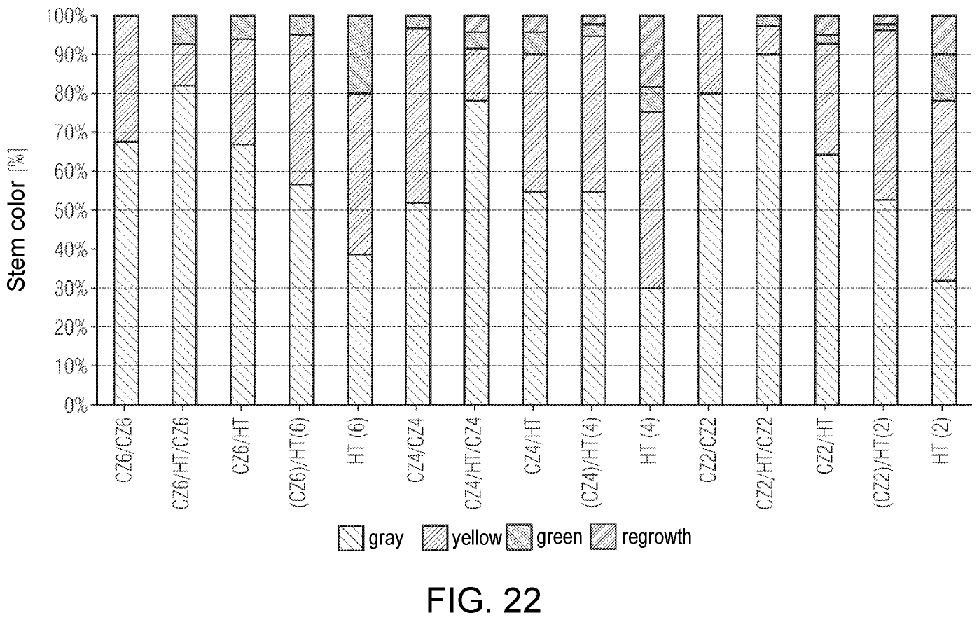

FIG. 22 shows the results of the crop.zone treatment of potatoes in combination with haulm topping. The figure shows the percentage of green, yellow and gray stems and resprouting as green or yellow culms (resprouting) 20 days after the first crop.zone treatment. The arrangement of the bars within the speed groups corresponds to the spatial arrangement in the field: crop.zone treatment with 6 km/h (left columns), 4 km/h (middle columns) and 2 km/h (right columns). The abbreviations mean: CZ=crop.zone treatment, (CZ)=secondary track partially treated by crop.zone because of potato plant projection, HT=haulm topping as standard method (number only as neighborhood position designation). Double treatment with crop.zone (CZ/CZ) represents the best compromise between high percentage of gray stems and at the same time minimizing resprouting.

The combination of double crop.zone treatment with interspersed haulm topping (CZ/HT/CZ) yielded the highest percentage of gray stems at all speeds. At the same time, haulm topping in any combination of methods left a significant amount of green stems and resulted in resprouting on up to 18% of stems depending on soil moisture or other soil-related factors. Even the double crop.zone treatment with interspersed haulm topping did not completely prevent reappearance, although this is critical for viral infections caused by aphids. A combination of single crop.zone treatment followed by haulm topping (CZ/HT) resulted in more green residual leaves and resprouting than a double crop.zone treatment at all speeds. Interesting in the experiment is the influence of neighboring rows by the crop.zone treatment. As the potato plants spread widely into the neighboring row, even in the herbaceous-only row ((CZ)/HT) next to the crop.zone treated row (CZ/HT), an effect is seen at all travel speeds that is well above the effect of the herbaceous blow alone.

Overall, the results of experiment 3 show that even in a dry year, a double crop.zone treatment (CZ/CZ) is the most effective siccation method compared to haulm topping and compared to combinations of the two methods, achieving a relatively high percentage of gray stems while minimizing the particularly undesirable resprouting. Driving at 6 km/h with a nominal 16 kWh/h each guarantees high surface performance and low energy requirements.

Weed whacking does not result in any relevant siccation benefits and only appears to make sense if the farmer wants to reduce the starch content of the potatoes through reseeding. For wetter years, even greater resprouting can be expected, which may result in significant chemical secondary treatments after haulm knockdown (including insecticide treatment) or may also require tertiary treatment with crop.zone or chemical tertiary treatment.

Moreover, the additional haulm topping (CZ7HT/CZ), which ranks second, can produce much more green potatoes, as the working width rarely exceeds 3 m and accordingly many dams are damaged or even potatoes are exposed superficially (crop.zone 6 m or in the future 12 m or more). Short-cut stems are an additional source of viral and fungal infection occurrence, and further chemical treatment may be needed to minimize these risks.

Reference Numerals

| | |
|---|---|
| 1 | device |
| 10 | first module |
| 11 | nozzle |
| 13 | non-selective herbicides |
| 20 | second module |
| 21 | applicator |
| 30 | carrier vehicle |
| 40 | plant |
| 41 | leaf |
| 41a | dead leaf |
| 42 | root |
| 42a | dead root |
| 43 | stem |
| 43a | dead stem |
| 44 | soil |
| 45 | plant spine |
| 46 | plant hair |
| 47 | plant wax |
| 50 | transition resistance lowering medium |
| 51 | foam |

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-11. (canceled)

12. A method for increasing an effect of electrical current applied to plants, comprising:
applying a resistance-reducing substance mixture to plants; and
applying an electrical current to the plants to which the resistance-reducing substance mixture has been applied, wherein the resistance-reducing substance mixture includes a first component that reduces an electrical contact resistance near a surface of the plant, wherein the first component includes a surfactant, wherein the resistance-reducing substance mixture includes a second component that increases viscosity of the resistance-reducing substance mixture, and wherein the resistance-reducing substance mixture includes a substance selected from the group consisting of: a pure silica, a pyrogenic silica, a mixed oxide, a magnesium silicate, an organic additive based on a biogenic oil, a polyamide, and a modified carbohydrate.

13. The method of claim 12, wherein the resistance-reducing substance mixture includes a third component that increases conductivity of the resistance-reducing substance mixture, wherein the third component includes a substance selected from the group consisting of: an inorganic salt, carbon, a humic substance, chelated iron, a chelated metal ion, and a metal ion complexed by a polydentate complexing agent.

14. The method of claim 12, wherein the resistance-reducing substance mixture includes a third component that reduces evaporation of the resistance-reducing substance mixture, and wherein the third component is selected from the group consisting of: an oil, a microgel, and a polyalcohol.

15. The method of claim 12, wherein the resistance-reducing substance mixture includes a third component that softens wax on the plants, and wherein the third component is selected from the group consisting of: an oil, an ester, an alcohol, a polypeptide, and an alkoxylated triglyceride.

16. The method of claim 12, wherein the resistance-reducing substance mixture includes a third component that dissolves wax on the plants, and wherein the third component is selected from the group consisting of: a carboxylic acid, a terpene, an aromatic oil, an alkali, a functionalized polypeptide, an inorganic alkali, and an organic alkali.

17. The method of claim 12, wherein the resistance-reducing substance mixture includes a physical-phytotoxic substance that breaks down a wax layer of the plants.

18. The method of claim 12, wherein the resistance-reducing substance mixture includes an adhesion-promoting foaming agent selected from the group consisting of: a surfactant, a protein, and a derivative of a surfactant.

19. The method of claim 12, wherein the resistance-reducing substance mixture includes an adhesion-promoting substance selected from the group consisting of: an organic rheological additive, an inorganic rheological additive, a pure silica, a pyrogenic silica, a mixed oxide, a magnesium layer silicate, an organic additive based on a biogenic oil, and a polyamide.

20. The method of claim 12, wherein the resistance-reducing substance mixture includes an ionization-promoting substance selected from the group consisting of: an inorganic salt, carbon, a humic substance, a chelated iron, and a chelated metal ion.

21. The method of claim 12, wherein the resistance-reducing substance mixture includes a carrier liquid selected from the group consisting of: water, a vegetable oil, an esters of vegetable oils, and a fatty acid ester.

22. The method of claim 12, wherein the resistance-reducing substance mixture includes an emulsifier selected from the group consisting of: Poloxamer, a medium-chain triglyceride, and a medium-chain biocide.

23. A method of applying electric current to plants to achieve a herbicidal effect, comprising:
selectively applying a substance mixture to a plant surface, wherein the substance mixture includes a first component that lowers an electrical contact resistance on the plant surface, wherein the first component includes a surfactant, wherein the substance mixture includes a second component that increases viscosity, and wherein the second component is selected from the group consisting of; a pure silica, a pyrogenic silica, a mixed oxide, a magnesium silicate, an organic additive based on a biogenic oil, a polyamide, and a modified carbohydrate;
applying electric current to the plant surface after the substance mixture has been applied to the plant surface.

24. The method of claim 23, wherein the substance mixture includes a third component that increases conductivity of the substance mixture, wherein the third component includes a substance selected from the group consisting of: an inorganic salt, carbon, a humic substance, chelated iron, a chelated metal ion, and a metal ion complexed by a polydentate complexing agent.

25. The method of claim 23, wherein the substance mixture includes a third component that reduces evaporation of the substance mixture, and wherein the third component is selected from the group consisting of: an oil, a microgel, and a polyalcohol.

26. The method of claim 23, wherein the substance mixture includes a third component that softens wax on the plant surface, wherein the third component is selected from the group consisting of: an oil, an ester, an alcohol, a polypeptide, and an alkoxylated triglyceride.

27. The method of claim 23, wherein the substance mixture includes a third component that dissolves wax on the plant surface, and wherein the third component is selected from the group consisting of: a carboxylic acid, a terpene, an aromatic oil, an alkali, a functionalized polypeptide, an inorganic alkali, and an organic alkali.

28. The method of claim 23, wherein the substance mixture includes a physical-phytotoxic substance that breaks down a wax layer on the plant surface.

29. The method of claim 23, wherein the substance mixture includes an adhesion-promoting foaming agent selected from the group consisting of: a surfactant, a protein, and a derivative of a surfactant.

30. The method of claim 23, wherein the substance mixture includes an adhesion-promoting substance selected from the group consisting of: an organic rheological additive, an inorganic rheological additive, a pure silica, a pyrogenic silica, a mixed oxide, a magnesium layer silicate, an organic additive based on a biogenic oil, and a polyamide.

31. The method of claim 23, wherein the substance mixture includes an ionization-promoting substance selected from the group consisting of: an inorganic salt, carbon, a humic substance, a chelated iron, and a chelated metal ion.
